(19) United States
(12) Patent Application Publication
(10) Pub. No.: US 2026/0112308 A1
(43) Pub. Date: Apr. 23, 2026

(54) DISPLAY PANEL AND ELECTRONIC DEVICE INCLUDING THE SAME

(71) Applicant: Samsung Display Co., Ltd., Yongin-si (KR)

(72) Inventors: Hyojoon Song, Yongin-si (KR); Junyoung Min, Yongin-si (KR); Sungeun Kim, Yongin-si (KR); Junwon Choi, Yongin-si (KR)

(73) Assignee: Samsung Display Co., Ltd., Yongin-si (KR)

(21) Appl. No.: 19/270,882

(22) Filed: Jul. 16, 2025

(30) Foreign Application Priority Data
Oct. 22, 2024 (KR) 10-2024-0145150

(51) Int. Cl. G09G 3/32

(52) U.S. Cl. CPC G09G 3/32; G09G 2310/0267; G09G 2330/022

(57) ABSTRACT

A display panel includes a plurality of pixel circuits disposed in a display area, and a scan driver disposed in a peripheral area adjacent to the display area and including a first driving circuit and a second driving circuit. The first driving circuit includes a plurality of first stages that outputs first scan signals to the plurality of pixel circuits, and the second driving circuit includes a plurality of second stages that outputs second scan signals to the plurality of pixel circuits. The plurality of first stages are disposed in odd-numbered rows and the plurality of second stages are disposed in even-numbered rows.

### CROSS-REFERENCE TO RELATED APPLICATION(S)

This application claims priority to and benefits of Korean Patent Application No. 10-2024-0145150 under 35 U.S.C. § 119, filed on Oct. 22, 2024, in the Korean Intellectual Property Office (KIPO), the entire contents of which are incorporated herein by reference.

### BACKGROUND

### 1. Technical Field

Embodiments relate to a display panel and an electronic device including the same.

### 2. Description of the Related Art

An electronic device including a display panel includes a plurality of pixels disposed on the display panel, a scan driving circuit configured to drive the plurality of pixels, a data driving circuit, and a controller. The scan driving circuit includes stages connected to scan lines. The stages are configured to supply scan signals to the connected scan lines in response to signals from the controller.

### SUMMARY

Embodiments include a display panel, in which a display area is expanded by reducing the width of a scan driving circuit, and an electronic device including the display panel. However, this is only an example, and the scope of the disclosure is not limited thereto.

Additional aspects will be set forth in part in the description which follows and, in part, will be apparent from the description, or may be learned by practice of the embodiments of the disclosure.

According to an embodiment, a display panel may include a plurality of pixel circuits disposed in a display area, and a scan driver disposed in a peripheral area adjacent to the display area and including a first driving circuit and a second driving circuit. The first driving circuit may include a plurality of first stages that output first scan signals to the plurality of pixel circuits, the second driving circuit may include a plurality of second stages that output second scan signals to the plurality of pixel circuits, the plurality of first stages may be disposed in odd-numbered rows, and the plurality of second stages may be disposed in even-numbered rows.

In an embodiment, the display panel may further include a first carry signal line that connects an input terminal of a first stage located at an n^{th} position among the plurality of first stages to an output terminal of a first stage located at an (n-1)^{th} position among the plurality of first stages, a second carry signal line that connects an input terminal of a second stage located at an n^{th} position among the plurality of second stages to an output terminal of a second stage located at an (n-1)^{th} position among the plurality of second stages. n may be a natural number greater than or equal to 2.

In an embodiment, in a plan view, the first carry signal line may intersect the second carry signal line.

In an embodiment, the first carry signal line and the second carry signal line may be disposed on different layers in an area where the first carry signal line and the second carry signal line intersect each other.

In an embodiment, a first start signal may be input to an input terminal of a first stage located at a first position among the plurality of first stages, and a second start signal that is different from the first start signal may be input to an input terminal of a second stage located at a first position among the plurality of second stages.

In an embodiment, a first scan signal output by the first stage located at the (n-1)^{th} position may be input to the input terminal of the first stage located at the n^{th} position among the plurality of first stages, and a second scan signal output by the second stage located at the (n-1)^{th} position may be input to the input terminal of the second stage located at the n^{th} position among the plurality of second stages.

In an embodiment, the display panel may further include clock lines connected to the scan driver. The clock lines may include a first clock line to which a first clock signal is input and a second clock line to which a second clock signal is input, and the first clock signal and the second clock signal may include signals having a same waveform with a shifted phase.

In an embodiment, the plurality of first stages and the plurality of second stages may each include a first clock terminal and a second clock terminal, the first clock line and the second clock line may be alternately connected to the first clock terminals of the plurality of first stages and the plurality of second stages, and the second clock line and the first clock line may be alternately connected to the second clock terminals of the plurality of first stages and the plurality of second stages.

In an embodiment, the display panel may further include clock lines connected to the scan driver. The clock lines may include a first clock line to which a first clock signal is input, a second clock line to which a second clock signal is input, a third clock line to which a third clock signal is input, and a fourth clock line to which a fourth clock signal is input, the first clock signal and the second clock signal may include signals having a same waveform with a shifted phase, and the third clock signal and the fourth clock signal may include signals having a same waveform with a shifted phase.

In an embodiment, the plurality of first stages and the plurality of second stages may each include a first clock terminal and a second clock terminal, the first clock line and the second clock line may be alternately connected to the first clock terminals of the plurality of first stages, the second clock line and the first clock line may be alternately connected to the second clock terminals of the plurality of first stages, the third clock line and the fourth clock line may be alternately connected to the first clock terminals of the plurality of second stages, and the fourth clock line and the third clock line may be alternately connected to the second clock terminals of the plurality of second stages.

In an embodiment, a first stage located at an i^{th} position among the plurality of first stages may output a first scan signal to ones of the plurality of pixel circuits disposed in a (2i-1)^{th} row and a 2i^{th} row, and a second stage located at an i^{th} position among the plurality of second stages may output a second scan signal to the ones of the plurality of pixel circuits disposed in the (2i-1)^{th} row and the 2i^{th} row, and i may be a natural number greater than or equal to 1.

In an embodiment, the scan driver may further include a third driving circuit. The third driving circuit may include a plurality of third stages that output third scan signals to the plurality of pixel circuits, and the plurality of third stages may be spaced apart from the plurality of first stages and the plurality of second stages in a first direction.

In an embodiment, a width of one of the plurality of first stages in a second direction intersecting the first direction may be equal to a width of one of the plurality of second stages in the second direction.

In an embodiment, a width of one of the plurality of third stages may be equal to a sum of the width of the one of the plurality of first stages and the width of the one of plurality of the second stages.

According to an embodiment, a display panel may include a plurality of pixel circuits disposed in a display area, and a scan driver disposed in a peripheral area adjacent to the display area and including a first driving circuit, a second driving circuit, and a third driving circuit. The first driving circuit may include a plurality of first stages that output first scan signals to the plurality of pixel circuits, the second driving circuit may include a plurality of second stages that output second scan signals to the plurality of pixel circuits, the third driving circuit may include a plurality of third stages that output third scan signals to the plurality of pixel circuits. The plurality of first stages may be disposed in a (3j-2)^{th} row, the plurality of second stages may be disposed in a (3j-1)^{th} row, and the plurality of third stages may be disposed in a 3j^{th} row. j may be a natural number greater than or equal to 1.

In an embodiment, the display panel may further include a first carry signal line that connects an input terminal of a first stage located at an n^{th} position among the plurality of first stages to an output terminal of a first stage located at an (n-1)^{th} position among the plurality of first stages, a second carry signal line that connects an input terminal of a second stage located at an n^{th} position among the plurality of second stages to an output terminal of a second stage located at an (n-1)^{th} position among the plurality of second stages, and a third carry signal line that connects an input terminal of a third stage located at an n^{th} position among the plurality of third stages to an output terminal of a third stage located at an (n-1)^{th} position among the plurality of third stages. n may be a natural number greater than or equal to 2.

In an embodiment, the display panel may further include clock lines connected to the scan driver. The clock lines may include a first clock line to which a first clock signal is input, a second clock line to which a second clock signal is input, a third clock line to which a third clock signal is input, and a fourth clock line to which a fourth clock signal is input. The first clock signal and the second clock signal may include signals having a same waveform with a shifted phase, and the third clock signal and the fourth clock signal may include signals having a same waveform with a shifted phase.

In an embodiment, the plurality of first stages, the plurality of second stages, and the plurality of third stages may each include a first clock terminal and a second clock terminal, the first clock line and the second clock line may be alternately connected to the first clock terminals of the plurality of first stages, the second clock line and the first clock line may be alternately connected to the second clock terminals of the plurality of first stages, the first clock line and the second clock line may be alternately connected to the first clock terminals of the plurality of second stages, the second clock line and the first clock line may be alternately connected to the second clock terminals of the plurality of second stages, the third clock line and the fourth clock line may be alternately connected to the first clock terminals of the plurality of third stages, and the fourth clock line and the third clock line may be alternately connected to the second clock terminals of the plurality of third stages.

In an embodiment, a first stage located at an i^{th} position among the plurality of first stages may output a first scan signal to ones of the plurality of pixel circuits disposed in a (2i-1)^{th} row and a 2i^{th} row, a second stage located at an i^{th} position among the plurality of second stages may output a second scan signal to the ones of the plurality of pixel circuits disposed in the (2i-1)^{th} row and the 2i^{th} row, and a third stage located at an i^{th} position among the plurality of third stages may output a third scan signal to the ones of the plurality of pixel circuits disposed in the (2i-1)^{th} row and the 2i^{th} row. i may be a natural number greater than or equal to 1.

According to an embodiment, an electronic device may include a display panel, and a lower cover constituting an exterior of the electronic device and having an opening exposing a portion of the display panel in a front surface. The display panel may include a plurality of pixel circuits disposed in a display area and a scan driver disposed in a peripheral area adjacent to the display area and including a first driving circuit and a second driving circuit. The first driving circuit may include a plurality of first stages that output first scan signals to the plurality of pixel circuits, the second driving circuit may include a plurality of second stages that output second scan signals to the plurality of pixel circuits, the plurality of first stages and the plurality of second stages are disposed alternately in different rows.

According to an embodiment, an electronic device may include a display panel, and a lower cover constituting an exterior of the electronic device and having an opening exposing a portion of the display panel in a front surface. The display panel may include a plurality of pixel circuits disposed in a display area and a scan driver disposed in a peripheral area adjacent to the display area and including a first driving circuit, a second driving circuit, and a third driving circuit. The first driving circuit may include a plurality of first stages that output first scan signals to the plurality of pixel circuits, the second driving circuit may include a plurality of second stages that output second scan signals to the plurality of pixel circuits, the third driving circuit may include a plurality of third stages that output third scan signals to the plurality of pixel circuits, the plurality of first stages may be disposed in a (3j-2)^{th} row, the plurality of second stages may be disposed in a (3j-1)^{th} row, and the plurality of third stages may be disposed in a 3j^{th} row. j may be a natural number greater than or equal to 1.

Other aspects, features, and advantages of the disclosure will become better understood through the accompanying drawings, the appended claims, and the detailed description.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating an electronic device according to an embodiment;

FIG. 2 is an exploded perspective view illustrating an electronic device according to an embodiment;

FIG. 3 is a schematic block diagram illustrating an electronic device according to an embodiment;

FIG. 4 is a plan view schematically illustrating a display panel according to an embodiment;

FIG. 5 is a schematic diagram of an equivalent circuit of a pixel according to an embodiment;

FIG. 6 is a schematic cross-sectional view schematically illustrating a display panel according to an embodiment;

FIG. 7 is a schematic block diagram schematically illustrating an electronic device according to an embodiment;

FIGS. 8A and 8B are plan views schematically illustrating a scan driver according to an embodiment;

FIG. 9 is a plan view schematically illustrating a first emission control driving circuit and a second emission control driving circuit according to an embodiment;

FIG. 10 is a plan view schematically illustrating a first emission control driving circuit and a second emission control driving circuit according to an embodiment;

FIG. 11 is a plan view schematically illustrating a first gate driving circuit according to an embodiment;

FIG. 12 is a plan view schematically illustrating carry signal lines according to an embodiment;

FIG. 13 is a schematic cross-sectional view schematically illustrating carry signal lines according to an embodiment; and

FIG. 14 is a plan view schematically illustrating the layout of driving circuits according to an embodiment.

### DETAILED DESCRIPTION OF THE EMBODIMENTS

Reference will now be made in detail to embodiments, examples of which are illustrated in the accompanying drawings, wherein like reference numerals refer to like elements throughout. In this regard, the embodiments may have different forms and should not be construed as being limited to the descriptions set forth herein. Accordingly, the embodiments are merely described below, by referring to the figures, to explain aspects of the description.

In the specification and the claims, the phrase “at least one of” is intended to include the meaning of “at least one selected from the group of” for the purpose of its meaning and interpretation. For example, “at least one of A and B” may be understood to mean “A, B, or A and B.” In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

As the description allows for various changes and numerous embodiments, certain embodiments will be illustrated in the drawings and described in detail in the written description. Effects and features of the disclosure, and methods of achieving them will be clarified with reference to embodiments described below in detail with reference to the drawings. However, the disclosure is not limited to the following embodiments and may be embodied in various forms.

Hereinafter, embodiments will be described in detail with reference to the accompanying drawings. When describing embodiments with reference to the accompanying drawings, the same or corresponding elements are denoted by the same reference numerals, and redundant descriptions thereof are omitted.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Also, when an element is referred to as being “in contact” or “contacted” or the like to another element, the element may be in “electrical contact” or in “physical contact” with another element; or in “indirect contact”or in “direct contact”with another element.

It will be further understood that when layers, regions, or elements are referred to as being connected to each other, they may be directly connected to each other or indirectly connected to each other with intervening layers, regions, or elements therebetween. For example, when layers, regions, or elements are referred to as being electrically connected to each other, they may be directly electrically connected to each other or indirectly electrically connected to each other with intervening layers, regions, or elements therebetween.

In the disclosure, the x direction, the y direction, and the z direction are not limited to directions along three axes of the orthogonal coordinate system and may be interpreted in a broader sense. For example, the x direction, the y direction, and the z direction may be perpendicular to one another, or may represent different directions that are not perpendicular to one another.

The terms “in a plan view” as used herein may mean seeing a target portion from above (for example, seeing a target object in a direction perpendicular to an upper surface of a substrate), and the terms “in a cross-sectional view” as used herein may mean seeing a vertically cut cross-section of a target portion from a side.

In the disclosure, when a first element “overlaps” a second element, it may mean that the first element is disposed above or below the second element so that at least a portion of the first element overlaps the second element in a plan view.

Herein, the term “dead space” may be understood as a space which is devoted to accommodating one or more components that, either singularly or plurally, perform an intended function.

In the disclosure, the terms “on” and “off” used in connection with a state of an element may refer to an activated state of the element and an inactive (or deactivated) state of the element, respectively. The terms “on” and “off” used in connection with a signal received by an element may refer to a signal that activates the element and a signal that deactivates the element, respectively. The element may be activated by a high-level voltage or a low-level voltage. For example, a P-channel transistor (a P-type transistor) is activated by a low-level voltage, and an N-channel transistor (an N-type transistor) is activated by a high-level voltage. Therefore, it will be understood that the “on” voltages for the P-type transistor and the N-type transistor are opposite (low/high) voltage levels.

When a certain embodiment may be implemented differently, a specific process order may be performed differently from the described order. For example, two consecutively described processes may be performed substantially at the same time or performed in an order opposite to the stated order.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

Also, sizes of elements in the drawings may be exaggerated or reduced for convenience of explanation. For example, because sizes and thicknesses of elements in the drawings are arbitrarily illustrated for convenience of explanation, the disclosure is not necessarily limited thereto.

Unless otherwise defined or implied herein, all terms (including technical and scientific terms) used have the same meaning as commonly understood by those skilled in the art to which this disclosure pertains. It will be further understood that terms, such as those defined in commonly used dictionaries, should be interpreted as having a meaning that is consistent with their meaning in the context of the relevant art and should not be interpreted in an ideal or excessively formal sense unless clearly defined in the specification.

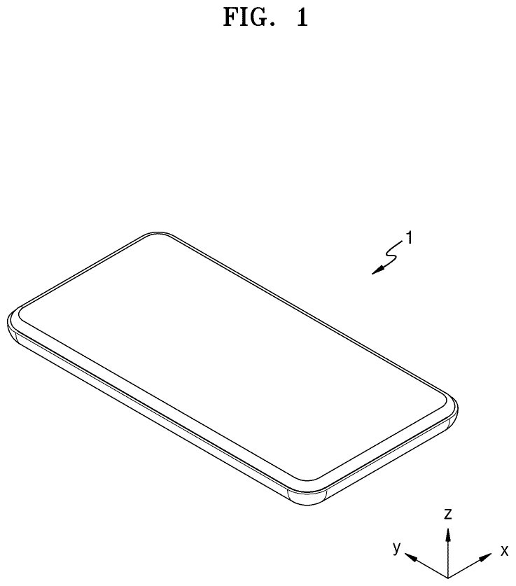

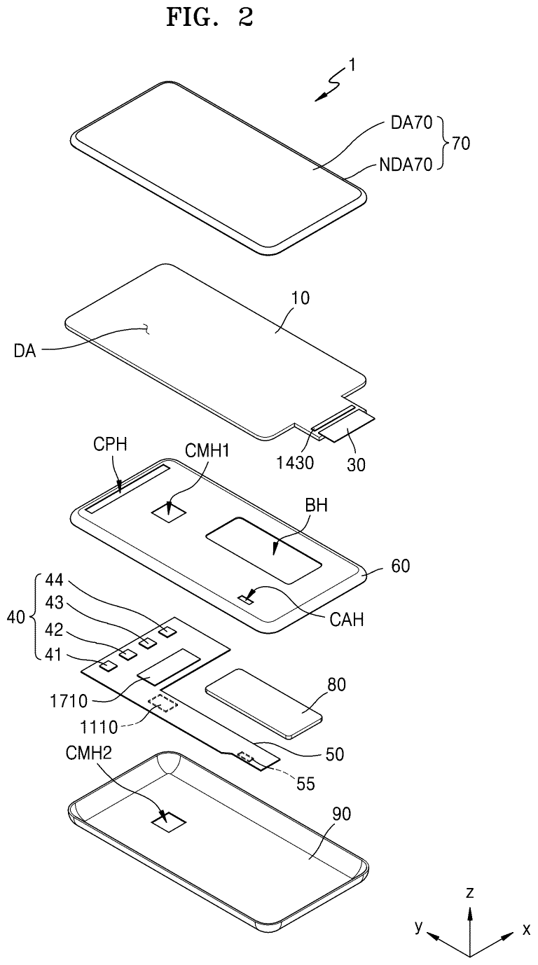

FIG. 1 is a perspective view illustrating an electronic device 1 according to an embodiment, and FIG. 2 is an exploded perspective view illustrating the electronic device 1 according to an embodiment.

Referring to FIGS. 1 and 2, the electronic device 1 may be configured to display a moving image or a still image. The electronic device 1 may be used as display screens of portable electronic devices, such as mobile phones, smartphones, tablet personal computers (PCs), mobile communication terminals, electronic organizers, e-books, portable multimedia players (PMPs), navigation systems, and ultra mobile PCs (UMPCs). The electronic device 1 may be used as display screens of various products, such as televisions, laptops, monitors, billboards, and Internet of things (IoT) devices. The electronic device 1 according to an embodiment may be used in wearable devices, such as smart watches, watch phones, glass-type displays, and head mounted displays (HMDs). The electronic device 1 according to an embodiment may be used in dashboards of automobiles, center information displays (CIDs) on the center fascia or dashboards of automobiles, room mirror displays replacing side mirrors of automobiles, and displays on the rear sides of front seats to serve as entertainment devices for backseat passengers of automobiles.

For convenience of description, an embodiment that the electronic device 1 is used as a smartphone is illustrated in FIGS. 1 and 2. The electronic device 1 according to an embodiment may include a cover window 70, a display panel 10, a data driver 1430, a display circuit board 30, components 40, a bracket 60, a main circuit board 50, a battery 80, and a lower cover 90.

In a plan view, “left,” “right,” “up,” and “down” may refer to the directions when the display panel 10 is viewed from the vertical direction of the display panel 10. For example, “left” may refer to the −x direction, “right” may refer to the +x direction, “up” may refer to the +y direction, and “down”may refer to the −y direction.

In a plan view, the electronic device 1 may have a rectangular shape. For example, the electronic device 1 may have a rectangular planar shape having a short side in a first direction (the x direction) and a long side in a second direction (the y direction), as illustrated in FIG. 1. Corners at which the short side in the first direction (the x direction) meets the long side in the second direction (the y direction) may be rounded to have a curvature, or may be at a right angle. The planar shape of the electronic device 1 is not limited to the rectangular shape, and may be other polygonal, elliptical, or irregular shapes.

The cover window 70 may be disposed on the upper portion of the display panel 10 to cover the upper surface of the display panel 10. Accordingly, the cover window 70 may protect the upper surface of the display panel 10.

The cover window 70 may include a transmissive cover portion DA70 corresponding to the display panel 10 and a light blocking cover portion NDA70 surrounding the transmissive cover portion DA70. The light blocking cover portion NDA70 may include an opaque material (e.g., a colored opaque material) that blocks light. The light blocking cover portion NDA70 may include a pattern that may be shown to a user when an image is not displayed.

The display panel 10 may be disposed below the cover window 70. The display panel 10 may overlap the transmissive cover portion DA70 of the cover window 70 in a plan view.

The display panel 10 may include a display area DA. The display area DA may be an area in which an image is displayed. The display area DA may include an area (hereinafter, a component area) configured to transmit light emitted from the components 40 disposed below the display panel 10. The components may include external modules, such as cameras or sensors using visible light, infrared light, or sound.

The display panel 10 may be a light-emitting display panel including a light-emitting diode. In an embodiment, the light-emitting diode may include an organic light-emitting diode including an organic emission layer. In another embodiment, the light-emitting diode may include an inorganic light-emitting diode including an inorganic material. The inorganic light-emitting diode may include a PN junction diode including inorganic semiconductor-based materials. In case that a voltage is applied to the PN junction diode in a forward direction, holes and electrons may be injected and recombined to generate energy, and the energy may be converted into light energy to emit light of a color. The inorganic light-emitting diode may have a width of several to hundreds of micrometers. In some embodiments, the inorganic light-emitting diode may be a micro light-emitting diode.

The display panel 10 may be a rigid display panel that is hardly bent because of high rigidity, or a flexible display panel that is bendable, foldable, or rollable because of high flexibility. For example, the display panel 10 may be a foldable display panel, a curved display panel with a curved display surface, a bended display panel in which areas other than a display surface are bent, a rollable display panel, or a stretchable display panel.

The display panel 10 may be a transparent display panel that is transparently implemented so that an object or background on the lower surface of the display panel 10 is seen from the upper surface of the display panel 10. In another embodiment, the display panel 10 may be a reflective display panel capable of reflecting an object or background on the upper surface of the display panel 10.

The data driver 1430 may be disposed on the display panel 10 in the form of an integrated circuit (IC). In another embodiment, the data driver 1430 may be disposed on the display circuit board 30.

The display circuit board 30 may be attached to a side of the display panel 10. The display circuit board 30 may be a flexible printed circuit board (FPCB) that is readily bendable, a rigid printed circuit board (PCB) that is rigid and thus hardly bendable, or a composite PCB that includes both a rigid PCB and an FPCB.

In an embodiment, a touch sensor driver may be disposed on the display circuit board 30. The touch sensor driver may be implemented as an IC. The touch sensor driver may be attached to the display circuit board 30. The touch sensor driver may be electrically connected to touch electrodes of a touch screen layer of the display panel 10 through the display circuit board 30.

The touch screen layer of the display panel 10 may sense user touch input by using at least one of various touch methods, including a resistive method and a capacitive method. For example, in case that the touch screen layer of the display panel 10 senses user touch input by using a capacitive method, the touch sensor driver may determine the presence or absence of the user touch by applying driving signals to driving electrodes among touch electrodes and sensing voltages charged in mutual capacitances between the driving electrodes and sensing electrodes through the sensing electrodes among the touch electrodes. The user touch may include contact touch and proximity touch. The contact touch may be a touch in which an object, such as a user's finger or a pen, is in direct contact with the cover window 70 disposed on the touch screen layer. The proximity touch may be a touch in which an object, such as a user's finger or a pen, is located close to the cover window 70, like hovering. The touch sensor driver may be configured to transmit sensor data to a main processor 1110 according to the sensed voltages, and the main processor 1110 may be configured to analyze the sensor data to calculate touch coordinates where the touch input has occurred.

In an embodiment, an auxiliary processor may be disposed on the display circuit board 30 to supply driving voltages for driving pixels of the display panel 10, the scan driver, and the data driver 1430.

The bracket 60 that supports the display panel 10 may be disposed below the display panel 10. The bracket 60 may include a plastic, a metal, or both a plastic and a metal. The bracket 60 may have a first camera hole CMH1 into which a camera module 1710 is inserted, a battery hole BH in which the battery 80 is disposed, and a cable hole CAH through which a cable connected to the display circuit board 30 passes. The bracket 60 may have a component hole CPH that overlaps the display panel 10 in a third direction (the z direction). The component hole CPH may overlap the components 40 of the main circuit board 50 in a third direction (the z direction). In an embodiment, the display area DA of the display panel 10 may overlap the components 40 of the main circuit board 50 in the third direction (the z direction). In another embodiment, the bracket 60 may not have the component hole CPH.

In an embodiment, the components 40 may include first to fourth components 41, 42, 43, and 44 each overlapping the display panel 10 in the third direction (the z direction). The first to fourth components 41, 42, 43, and 44 may include a proximity sensor, an illumination sensor, an iris sensor, a facial recognition sensor, and a camera (or an image sensor). The proximity sensor using infrared light may detect an object disposed close to the upper surface of the electronic device 1, and the illumination sensor may sense the brightness of light incident on the upper surface of the electronic device 1. The iris sensor may capture an image of an iris of a person disposed on the upper surface of the electronic device 1, and the camera may capture an image of an object disposed on the upper surface of the electronic device 1. The components 40 are not limited to the proximity sensor, the illumination sensor, the iris sensor, the facial recognition sensor, and the camera, and other modules described below may be disposed.

The main circuit board 50 and the battery 80 may be disposed below the bracket 60. The main circuit board 50 may be a PCB or an FPCB.

The main circuit board 50 may include the main processor 1110, the camera module 1710, a main connector 55, and the components 40. The main processor 1110 may be implemented as an IC. The camera module 1710 may be disposed on both the upper surface and the lower surface of the main circuit board 50. Each of the main processor 1110 and the main connector 55 may be disposed on either the upper surface or the lower surface of the main circuit board 50.

The camera module 1710 may process image frames (e.g., still images or moving images) obtained by the image sensor in a camera mode and may output the processed image frames to the main processor 1110. The camera module 1710 may include at least one of a camera sensor (e.g., charge-coupled device (CCD), complementary metal-oxide semiconductor (CMOS), etc.), a photo sensor (or an image sensor), or a laser sensor. The camera module 1710 may be connected to the image sensor among the components 40 and may process an image input to the image sensor.

The cable passing through the cable hole CAH of the bracket 60 may be connected to the main connector 55. Accordingly, the main circuit board 50 may be electrically connected to the display circuit board 30.

The lower cover 90 may constitute the exterior of the electronic device 10 and may have an opening exposing a portion of the display panel 10 in the front surface. The lower cover 90 may have a shape in which a surface corresponding to the display panel 10 is exposed and may be assembled with the display panel 10. The lower cover 90 may be disposed on an opposite side of the cover window 70 with the display panel 10 interposed between the lower cover 90 and the cover window 70. The lower cover 90 may be disposed below the main circuit board 50 and the battery 80. The lower cover 90 may be coupled and fixed to the bracket 60. The lower cover 90 may constitute the exterior of the lower surface of the display device 1. The lower cover 90 may include a plastic, a metal, or both a plastic and a metal.

The second camera hole CMH2 that exposes the lower surface of the camera module 1710 may be formed in the lower cover 90. The position of the camera module 1710 and the positions of the first and second camera holes CMH1 and CMH2 corresponding to the camera module 1710 are not limited to the embodiments illustrated in FIGS. 1 and 2 and may be variously changed.

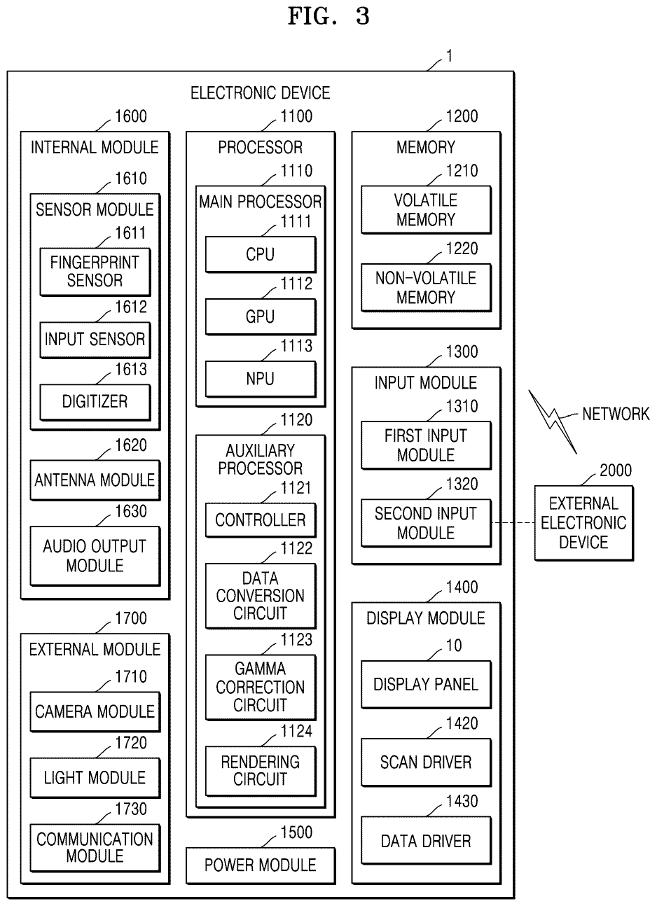

FIG. 3 is a schematic block diagram illustrating the electronic device 1 according to an embodiment.

Referring to FIG. 3, the electronic device 1 may include a processor 1100, a memory 1200, an input module 1300, a display module 1400, a power module 1500, an internal module 1600, and an external module 1700. According to an embodiment, at least one of the components described above may be omitted from the electronic device 1, or one or more other components may be added to the electronic device 1. In an embodiment, some components described above (e.g., the internal module 1600) may be integrated into another component (e.g., the display module 1400).

The processor 1100 may execute software to control at least one other component (e.g., a hardware or software component) of the electronic device 1 connected to the processor 1100 and perform various data processing or operations. According to an embodiment, as at least a part of data processing or operations, the processor 1100 may store commands or data received from another component (e.g., the input module 1300, a sensor module 1610, or a communication module 1730) in a volatile memory 1210, process the commands or data stored in the volatile memory 1210, and store resulting data in a non-volatile memory 1220.

The processor 1100 may include a main processor 1110 and an auxiliary processor 1120. The main processor 1110 may include at least one of a central processing unit (CPU) 1111 and an application processor (AP). The main processor 1110 may further include at least one of a graphics processing unit (GPU) 1112, a communication processor (CP), and an image signal processor (ISP). The main processor 1110 may further include a neural processing unit (NPU) 1113. The NPU 1113 may be a processor specialized in processing an artificial intelligence model. The artificial intelligence model may be generated through machine learning. The artificial intelligence model may include multiple artificial neural network layers. The artificial intelligence model may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination thereof, but the disclosure is not limited to the above example. The artificial intelligence model may additionally or alternatively include a software structure. At least two of the processing units and processors described above may be implemented as a single integrated configuration (e.g., a single chip), or the processing units and processors described above may be implemented as independent configurations (e.g., multiple chips).

The auxiliary processor 1120 may include a controller 1121. The controller 1121 may include an interface conversion circuit and a timing control circuit. The controller 1121 may receive an image signal from the main processor 1110, convert the data format of the image signal to match the interface specification with the display module 1400, and output the image data. The controller 1121 may output various control signals required to drive the display module 1400.

The auxiliary processor 1120 may further include a data processing circuit, such as a data conversion circuit 1122, a gamma correction circuit 1123, or a rendering circuit 1124. The data conversion circuit 1122 may receive image data from the controller 1121, compensate the image data so that the image is displayed at a desired luminance according to characteristics of the electronic device 1 or a user's settings, or convert the image data so as to reduce power consumption or compensate for afterimages. The gamma correction circuit 1123 may convert image data or gamma reference voltages so that the image displayed on the electronic device 1 has desired gamma characteristics. The rendering circuit 1124 may receive image data from the controller 1121 and render the image data by taking into account the pixel layout of the display panel 10 applied to the electronic device 1. At least one of the data conversion circuit 1122, the gamma correction circuit 1123, and the rendering circuit 1124 may be integrated into another component (e.g., the main processor 1110 or the controller 1121).

The memory 1200 may store various data used by at least one component of the electronic device 1 (e.g., the processor 1100 or the sensor module 1610) and input data or output data for commands related thereto. The memory 1200 may include at least one of the volatile memory 1210 and the non-volatile memory 1220.

The input module 1300 may receive commands or data to be used in the components of the electronic device 1 (e.g., the processor 1100, the sensor module 1610, or the audio output module 1630) from the outside of the electronic device 1 (e.g., a user or an external electronic device 2000).

The input module 1300 may include a first input module 1310 to which commands or data are input from the user and a second input module 1320 to which commands or data are input from the external electronic device 2000.

The first input module 1310 may include a microphone, a mouse, a keyboard, or a pen (e.g., a passive pen or an active pen). The first input module 1310 may include a touch input means or a mechanical input means, such as a button, a dome switch, a jog wheel, or a jog switch, which is located on the rear or side surface of the electronic device 1. The touch input means may include a touch screen layer of the display panel 10.

The second input module 1320 may be connected, in a wired or wireless manner, to an external electronic device 2000 of various types and connected to the electronic device 1. According to an embodiment, the second input module 1320 may include a high definition multimedia interface (HDMI), a universal serial bus (USB) interface, a secure digital (SD) card interface, or an audio interface. The second input module 1320 may include a connector which is physically connectable to the external electronic device 2000, for example, an HDMI connector, a USB connector, an SD card connector, or an audio connector (e.g., a headphone connector). In response to the connection of the external electronic device 2000 to the second input module 1320, the electronic device 1 may perform appropriate control related to the connected external electronic device 2000.

The display module 1400 may provide visual information to the user. The display module 1400 may include the display panel 10, a scan driver 1420, and the data driver 1430.

The display panel 10 may display (output) information processed by the electronic device 1. The display panel 10 may display execution screen information of an application driven by the electronic device 1, or user interface (UI) or graphical user interface (GUI) information based on the execution screen information.

The scan driver 1420 may be mounted on the display panel 10 as a driving chip. In another embodiment, the scan driver 1420 may be formed on (e.g., directly formed on) the display panel 10. For example, the scan driver 1420 may include an amorphous silicon TFT gate driver circuit (ASG), a low temperature polycrystalline silicon (LTPS) TFT gate driver circuit, or an oxide semiconductor TFT gate driver circuit (OSG), which is embedded in the display panel 10. The scan driver 1420 may receive a control signal from the controller 1121 and output scan signals to the display panel 10 in response to the control signal.

The data driver 1430 may receive a control signal from the controller 1121, convert image data into analog voltages (e.g., data voltages) in response to the control signal, and output the data voltages to the display panel 10.

The power module 1500 may supply power to the components of the electronic device 1. The power module 1500 may include a battery which is charged with a power supply voltage. The power module 1500 may include a connection port. The connection port may be included in the second input module 1320 to which an external charger that supplies power for charging the battery is connected. In another embodiment, the power module 1500 may include a wireless power transmission/reception member so as to enable wireless charging of the battery. The wireless power transmission/reception member may include multiple coil-type antenna radiators. The power module 1500 may include a power management integrated circuit (PMIC). The PMIC may supply optimized power to each component of the electronic device 1.

The electronic device 1 may further include the internal module 1600 and the external module 1700. The internal module 1600 may include the sensor module 1610, the antenna module 1620, and the audio output module 1630. The external module 1700 may include a camera module 1710, a light module 1720, and the communication module 1730.

The sensor module 1610 may include a touch sensor driver and touch electrodes of the touch screen layer of the display panel 10. The sensor module 1610 may sense input by a user's body or input by a pen and may generate an electrical signal or a data value corresponding to the input. The sensor module 1610 may include at least one of a fingerprint sensor 1611, an input sensor 1612, and a digitizer 1613.

The fingerprint sensor 1611 may generate a data value corresponding to a user's fingerprint. The fingerprint sensor 1611 may include at least one of an optical fingerprint sensor and a capacitive fingerprint sensor.

The input sensor 1612 may generate a data value corresponding to coordinate information of the input by the user's body or the input by the pen. The input sensor 1612 may generate a data value based on the amount of change in electrostatic capacitance by the input. The input sensor 1612 may sense input by a passive pen or may transmit and receive data to and from an active pen.

The input sensor 1612 may also measure biometric signals, such as blood pressure, moisture, or body fat. For example, in case that the user touches a sensor layer or a sensing panel with a part of his/her body and does not move for a certain time, the input sensor 1612 may detect biometric signals based on a change in electric field caused by the part of his/her body and output information desired by the user to the display module 1400.

The digitizer 1613 may generate a data value corresponding to coordinate information input by the pen. The digitizer 1613 may generate a data value based on the amount of change in electromagnetism by the input. The digitizer 1613 may sense input by a passive pen, or may transmit and receive data to and from an active pen.

In an embodiment, at least one of the fingerprint sensor 1611, the input sensor 1612, and the digitizer 1613 may be embedded into the display panel 10. For example, at least one of the fingerprint sensor 1611, the input sensor 1612, and the digitizer 1613 may be formed through a process that is continuous with the process of forming the pixel circuits and the light-emitting diodes of the display panel 10. Due to this, the display panel 10 may function as one of the input modules 1300 configured to provide an input interface between the electronic device 1 and the user and may also function as the display module 1400 configured to provide an output interface between the electronic device 1 and the user.

In another embodiment, at least two of the fingerprint sensor 1611, the input sensor 1612, and the digitizer 1613 may be integrated into a single sensing panel through a same process. The sensing panel may be disposed between the display panel 10 and a window on the upper side of the display panel 10, but the disclosure is not limited thereto.

The antenna module 1620 may include one or more antennas which transmit signals or power to the outside or receive signals or power from the outside. According to an embodiment, the communication module 1730 may transmit and receive signals to and from an external electronic device through an antenna suitable for a communication method. An antenna pattern of the antenna module 1620 may be integrated into one component of the display module 1400 (e.g., the display panel 10) or the input sensor 1612.

The audio output module 1630 may be a device configured to output an audio signal to the outside of the electronic device 1 and may output audio data received from the communication module 1730 or stored in the memory 1200 in a call signal reception mode, a call mode, a recording mode, a voice recognition mode, a broadcast reception mode, etc. The audio output module 1630 may output an audio signal related to the function performed in the electronic device 1 (e.g., a call signal reception sound, a message reception sound, etc.). The audio output module 1630 may include a receiver and a speaker. At least one of the receiver and the speaker may be a sound generation device that is attached to the lower portion of the display panel 10 and vibrates the display panel 10 to output sound. The sound generation device may be a piezoelectric element or a piezoelectric actuator that contracts and expands in response to an electrical signal, or may be an exciter that generates a magnetic force by using a voice coil and vibrates the display panel 10.

The camera module 1710 may capture still images and moving images. According to an embodiment, the camera module 1710 may include one or more lenses, image sensors, or image signal processors. The camera module 1710 may further include an IR camera capable of measuring the presence or absence of the user, the user's location, the user's line of sight, or the like.

The light module 1720 may output a signal to notify the occurrence of an event by using light from a light source or provide light so as to obtain an image. Examples of the occurrence of the event may include message reception, call signal reception, missed call, alarm, schedule reminder, email reception, and notification of battery charge capacity information. The light module 1720 may include a light-emitting diode or a xenon lamp. The light module 1720 may emit light of one or more colors to the front or back of the electronic device 1. The light module 1720 may operate in conjunction with the camera module 1710 or may operate independently.

The communication module 1730 may support establishment of a wired or wireless communication channel between the electronic device 1 and the external electronic device 2000 and may support performance of communication through the established communication channel. The communication module 1730 may include one or all of a wireless communication module (e.g., a cellular communication module, a short-range wireless communication module, or a global navigation satellite system (GNSS) communication module) and a wired communication module (e.g., a local area network (LAN) communication module or a power line communication module). The communication module 1730 may transmit and receive wireless signals on the Internet by using at least one of wireless LAN (WLAN), Wireless-Fidelity (Wi-Fi), Wi-Fi Direct, and digital living network alliance (DLNA). The communication module 1730 may support short-range communication by using at least one of Bluetooth™, radio frequency identification (RFID), Infrared Data Association (IrDA), Ultra-Wideband (UWB), ZigBee, Near Field Communication (NFC), Wi-Fi, Wi-Fi Direct, and Wireless USB. Various types of the communication module 1730 described above may be implemented as a single chip or separate chips.

The electronic device 1 may output a variety of information through the display module 1400 in an operating system. In case that the processor 1100 executes the application stored in the memory 1200, the display module 1400 may provide application information to a user through the display panel 10.

The processor 1100 may output commands or data to the display module 1400, the audio output module 1630, the camera module 1710, or the light module 1720, based on input data received from the input module 1300 or the sensor module 1610. For example, the processor 1100 may generate image data corresponding to the input data and output the generated image data to the display module 1400, or may generate command data corresponding to the input data and output the generated command data to the camera module 1710 or the light module 1720. In case that no input data is received from the input module 1300 for a certain time, the processor 1100 may switch the operation mode of the electronic device 1 to a low power mode or a sleep mode so as to reduce power consumption of the electronic device 1.

The processor 1100 may obtain external input through the input module 1300 or the sensor module 1610 and execute an application corresponding to the external input. For example, in case that the user selects a camera icon displayed on the display panel 10, the processor 1100 may obtain user input through the input sensor 1612 and activate the camera module 1710. The processor 1100 may transmit, to the display module 1400, image data corresponding to a captured image obtained through the camera module 1710. The display module 1400 may display an image corresponding to the captured image on the display panel 10.

For example, in case that personal information authentication is performed on the display module 1400, the fingerprint sensor 1611 may obtain input fingerprint information as input data. The processor 1100 may compare the input data obtained through the fingerprint sensor 1611 with authentication data stored in the memory 1200 and execute an application based on a comparison result. The display module 1400 may display information executed according to logics of the application on the display panel 10.

For example, in case that the user selects a music streaming icon displayed on the display module 1400, the processor 1100 may obtain user input through the input sensor 1612 and activate a music streaming application stored in the memory 1200. In case that a music execution command is input in the music streaming application, the processor 1100 may activate the audio output module 1630 to provide, to the user, audio information corresponding to the music execution command.

Some of the components described above may be connected to each other through a communication method between peripheral devices (e.g., a bus, a general purpose input/output (GPIO), a serial peripheral interface (SPI), a mobile industry processor interface (MIPI), or an ultra path interconnect (UPI) link) and may exchange signals (e.g., commands or data) with each other. In an embodiment, the main processor 1110 may transmit image signals to the auxiliary processor 1120 through an MIPI.

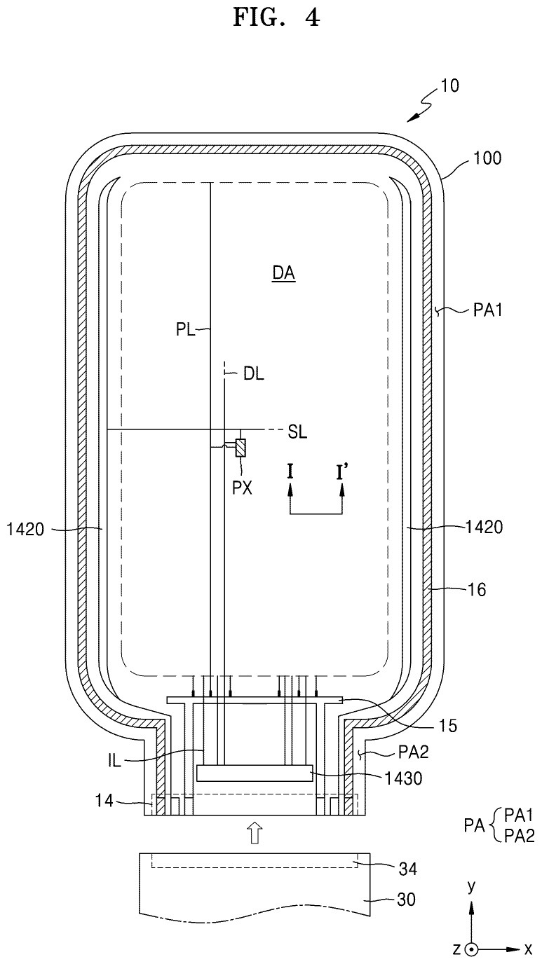

FIG. 4 is a plan view schematically illustrating a display panel 10 according to an embodiment.

Referring to FIG. 4, the display panel 10 may include a display area DA and a peripheral area PA outside the display area DA. The display area DA may be an area in which an image is displayed. Multiple pixels PX may be disposed in the display area DA. The display area DA may have various shapes in a plan view, for example, a circular shape, an elliptical shape, a polygonal shape, or a specific figure shape. For example, FIG. 4 schematically illustrates that the display area DA has a substantially rectangular shape with round corners.

The peripheral area PA may be disposed adjacent to the display area DA. The peripheral area PA may include a first peripheral area PA1 disposed to surround at least a portion of the display area DA and a second peripheral area PA2 disposed adjacent to a side of the display area DA and extending in the second direction (e.g., the y direction). The width of the second peripheral area PA2 in the first direction (e.g., the x direction) may be narrower than the width of the display area DA. Such a structure may facilitate bending of at least a portion of the second peripheral area PA2. In an embodiment, the display panel 10 may be bendable about a bending axis crossing the second peripheral area PA2.

The planar shape of the display panel 10 illustrated in FIG. 4 and the shape of the substrate 100 included in the display panel 10 may be substantially the same. The expression that the display panel 10 includes the display area DA and the peripheral area PA outside the display area DA may indicate that the substrate 100 includes the display area DA and the peripheral area PA outside the display area DA. For convenience, it is assumed that the substrate 100 has the display area DA and the peripheral area PA.

The substrate 100 may include glass, a metal, or a polymer resin. The substrate 100 may include, for example, a polymer resin including a material such as polyethersulfone, polyacrylate, polyetherimide, polyethylene naphthalate, polyethylene terephthalate, polyphenylene sulfide, polyarylate, polyimide, polycarbonate, or cellulose acetate propionate. The substrate 100 may have a multilayer structure including two layers each including the polymer resin described above and an inorganic layer disposed between the two layers.

Pixels PX may be disposed in the display area DA. The display area DA may be configured to provide an image by using light emitted from the pixels PX. Each of the pixels PX may be a red sub-pixel, a green sub-pixel, or a blue sub-pixel. Each of the pixels may include a light-emitting diode as a display element. The light-emitting diode may be electrically connected to the pixel circuit. The pixel circuit and the light-emitting diode may be disposed in the display area DA.

The scan driver 1420, the data driver 1430, a pad 14, a first power voltage supply line 15, and a second power voltage supply line 16 may be disposed in the peripheral area PA.

The scan driver 1420 may be configured to provide a scan signal to each of the pixels through a scan line SL. The scan line SL may be a gate line connected to gates of switching transistors included in the pixel circuit. The scan signal may be a gate signal for turning on or off the switching transistors included in the pixel circuit. The scan driver 1420 may be disposed on both sides of the peripheral area PA with the display area DA interposed between the peripheral areas PA. Some pixel circuits disposed in the display area DA may be electrically connected to the scan driver 1420 disposed on the left side (the −x direction), and the remaining pixel circuits may be electrically connected to the scan driver 1420 disposed on the right side (the +x direction). In another embodiment, the scan driver 1420 may be disposed only on one side of the peripheral area PA.

The pad 14 may be disposed in the second peripheral area PA2 of the substrate 100. The pad 14 may be exposed without being covered by an insulating layer and may be electrically connected to the display circuit board 30. A pad 34 of the display circuit board 30 may be electrically connected to the pad 14 of the display panel 10.

The display circuit board 30 may be configured to transmit a signal generated by the auxiliary processor (see 1120 of FIG. 3) to the display panel 10. A control signal generated by the auxiliary processor (see 1120 of FIG. 3) may be transmitted to the scan driver 1420 and the data driver 1430 through the display circuit board 30. In an embodiment, the display circuit board 30 may include a PMIC (not shown). The PMIC may be configured to provide a first power voltage ELVDD to the first power voltage supply line 15 and provide a second power voltage ELVSS to the second power voltage supply line 16. The first power voltage ELVDD may be provided to each of the pixel circuits through a driving voltage line PL connected to the first power voltage supply line 15, and the second power voltage ELVSS may be provided to an opposite electrode of a light-emitting diode LED connected to the second power voltage supply line 16. The first power supply voltage line 15 may extend in the first direction (e.g., the x direction). The second power supply voltage line 16 may have a loop shape with one side open and may partially surround the display area DA.

A data signal generated by the data driver 1430 may be transmitted to the pixel circuit through a data line DL electrically connected to an input line IL.

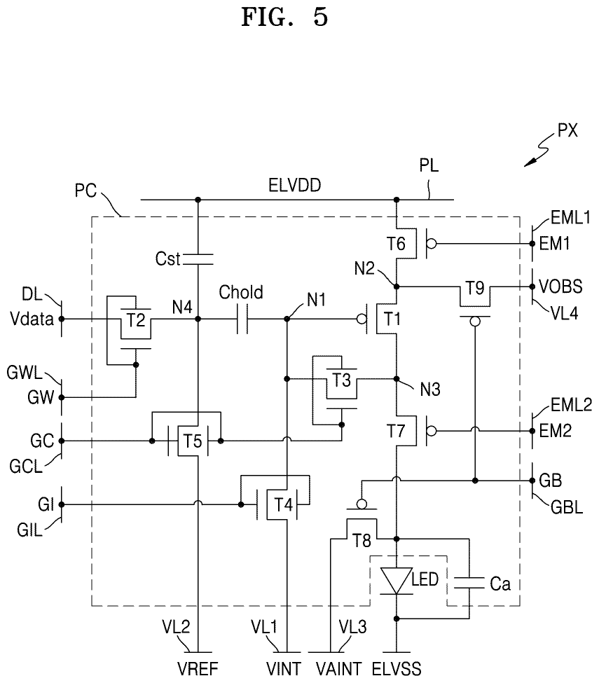

FIG. 5 is a schematic diagram of an equivalent circuit of a pixel PX according to an embodiment.

Referring to FIG. 5, the pixel PX may include a pixel circuit PC and a light-emitting diode LED as a display element connected to the pixel circuit PC.

The pixel circuit PC may include first to ninth transistors T1 to T9, a first capacitor Cst, and a second capacitor Chold. Signal lines connected to the pixel circuit PC may include a data line DL, a first gate line GWL, a second gate line GCL, a third gate line GIL, a fourth gate line GBL, a first emission control line EML1, a second emission control line EML2, a driving voltage line PL, a first initialization voltage line VL1, a reference voltage line VL2, a second initialization voltage line VL3, and a bias voltage line VL4.

The first transistor T1 may be a driving transistor in which an amount of a source-drain current is determined according to a gate-source voltage (Vgs), and the second to ninth transistors T2 to T9 may each be a switching transistor configured to be turned on or off according to a Vgs, substantially a gate voltage. The first to ninth transistors T1 to T9 may each be implemented as a thin-film transistor. Depending on the type (p-type or n-type) and/or operating conditions of transistor, a first terminal of each of the first to ninth transistors T1 to T9 may be a source or a drain and a second terminal thereof may be a terminal that is different from the first terminal. For example, in case that the first terminal is a source, the second terminal may be a drain.

The second to fifth transistors T2 to T5 may each be an N-channel transistor, and the first transistor T1 and the sixth to ninth transistors T6 to T9 may each be a P-channel transistor. In an embodiment, the P-channel transistor may be a silicon thin-film transistor including a silicon semiconductor, and the N-channel transistor may be an oxide thin-film transistor including an oxide semiconductor.

The semiconductor of the silicon thin-film transistor may include amorphous silicon, polysilicon, or the like. The semiconductor of the oxide thin-film transistor may include an oxide, such as amorphous indium-gallium-zinc-oxide (IGZO), zinc-oxide (ZnO), or titanium oxide (TiO).

A gate-on voltage of the gate signal for turning on the N-channel transistor may be a high level voltage (a first level voltage), and a gate-off voltage of the gate signal for turning off the N-channel transistor may be a low level voltage (a second level voltage). A gate-on voltage of the gate signal for turning on the P-channel transistor may be a low level voltage (a second level voltage), and a gate-off voltage of the gate signal for turning off the P-channel transistor may be a high level voltage (a first level voltage).

The first transistor T1 may be connected between the driving voltage line PL and the light-emitting diode LED. The first transistor T1 may be electrically connected to the driving voltage line PL via the sixth transistor T6 and may be electrically connected to the light-emitting diode LED via the seventh transistor T7. The first transistor T1 may include a gate connected to a first node N1, a first terminal connected to a second node N2, and a second terminal connected to a third node N3. The first transistor T1 may be configured to supply, to the light-emitting diode LED, a driving current corresponding to a voltage applied to the first node N1 according to a switching operation of the second transistor T2. In an embodiment, the first transistor T1 may be a dual-gate transistor that further includes a back gate to which the first power supply voltage ELVDD is supplied. The back gate may be disposed to face the gate with the semiconductor of the first transistor T1 interposed between the gate and the back gate. The back gate may be a lower gate disposed below the semiconductor, and the gate may be an upper gate disposed above the semiconductor.

The second transistor T2 may be connected between the data line DL and the fourth node N4. The second transistor T2 may include a gate connected to the first gate line GWL, a first terminal connected to the data line DL, and a second terminal connected to the fourth node N4. The second transistor T2 may be configured to be turned on in response to a first gate signal GW received through the first gate line GWL and transmit, to the fourth node N4, a data signal Vdata transmitted through the data line DL.

The third transistor T3 may be connected between the first node N1 and the third node N3. The third transistor T3 may include a gate connected to the second gate line GCL, a first terminal connected to the third node N3, and a second terminal connected to the first node N1. The third transistor T3 may be configured to be turned on in response to the second gate signal GC received through the second gate line GCL and diode-connect the first transistor T1. In case that the first transistor 1 is diode-connected, a threshold voltage of the first transistor T1 may be compensated for.

The fourth transistor T4 may be connected between the first node N1 and the first initialization voltage line VL1. The fourth transistor T4 may include a gate connected to the third gate line GIL, a first terminal connected to the first node N1, and a second terminal connected to the first initialization voltage line VL1. The fourth transistor T4 may be configured to be turned on in response to a third gate signal GI received through the third gate line GIL and initialize the first node N1, i.e., the gate of the first transistor T1 by transmitting a first initialization voltage VINT to the first node N1.

The fifth transistor T5 may be connected between the fourth node N4 and the reference voltage line VL2. The fifth transistor T5 may include a gate connected to the second gate line GCL, a first terminal connected to the fourth node N4, and a second terminal connected to the reference voltage line VL2. The gate of the fifth transistor T5 and the gate of the third transistor T3 may be connected to each other by the second gate line GCL. The fifth transistor T5 may be configured to be turned on in response to the second gate signal GC received through the second gate line GCL and transmit a reference voltage VREF to the fourth node N4.

In an embodiment, the second transistor T2, the third transistor T3, the fourth transistor T4, and the fifth transistor T5 may each be a dual-gate transistor that further includes a back gate. The back gate (a lower gate) may be disposed to face the gate (an upper gate) with a semiconductor interposed between the gate and the back gate and may be connected to the gate to receive a same gate signal.

The sixth transistor T6 may be connected between the driving voltage line PL and the second node N2. The seventh transistor T7 may be connected between the third node N3 and the light-emitting diode LED. The sixth transistor T6 may include a gate connected to the first emission control line EML1, a first terminal connected to the driving voltage line PL, and a second terminal connected to the second node N2. The seventh transistor T7 may include a gate connected to the second emission control line EML2, a first terminal connected to the third node N3, and a second terminal connected to a pixel electrode of the light-emitting diode LED. In case that the sixth transistor T6 is turned on in response to the first emission control signal EM1 received through the first emission control line EML1 and the seventh transistor T7 is turned on in response to the second emission control signal EM2 received through the second emission control line EML2, the driving current may flow to the light-emitting diode LED.

The eighth transistor T8 may be connected between the light-emitting diode LED and the second initialization voltage line VL3. The eighth transistor T8 may include a gate connected to the fourth gate line GBL, a first terminal connected to the second terminal of the seventh transistor T7 and the pixel electrode of the light-emitting diode LED, and a second terminal connected to the second initialization voltage line VL3. The eighth transistor T8 may be configured to be turned on in response to a fourth gate signal GB received through the fourth gate line GBL and initialize the pixel electrode of the light-emitting diode LED by transmitting a second initialization voltage VAINT to the pixel electrode of the light-emitting diode LED.

The ninth transistor T9 may be connected to the second node N2 and may be configured to supply a bias voltage VOBS to the first terminal of the first transistor T1. The ninth transistor T9 may include a gate connected to the fourth gate line GBL, a first terminal connected to the bias voltage line VL4, and a second terminal connected to the first node N1 connected to the first transistor T1. The ninth transistor T9 may be configured to be turned on in response to the fourth gate signal GB received through the fourth gate line GBL and transmit, to the first terminal of the first transistor T1, the bias voltage VOBS received through the bias voltage line VL4. The ninth transistor T9 may compensate for a change in current characteristics of the first transistor T1 by controlling the Vgs of the first transistor T1.

The first capacitor Cst may be connected between the driving voltage line PL and the fourth node N4. The first capacitor Cst may store a voltage corresponding to a voltage difference between the driving voltage line PL and the fourth node N4. The first capacitor Cst may store the data signal Vdata written through the second transistor T2.

The second capacitor Chold may be connected between the first node N1 and the fourth node N4. The second capacitor Chold may store a voltage corresponding to a voltage difference between the first node N1 and the fourth node N4.

The light-emitting diode LED may include the pixel electrode (e.g., an anode) and the opposite electrode (e.g., a cathode) facing the pixel electrode, and the opposite electrode may be configured to receive the second power supply voltage ELVSS. The light-emitting diode LED may be configured to display an image by receiving a driving current corresponding to the data signal Vdata from the first transistor T1 and emitting light having a color.

In an embodiment, the transistors included in the pixel circuit PC may each be a P-channel transistor. In an embodiment, the transistors included in the pixel circuit PC may each be an N-channel transistor.

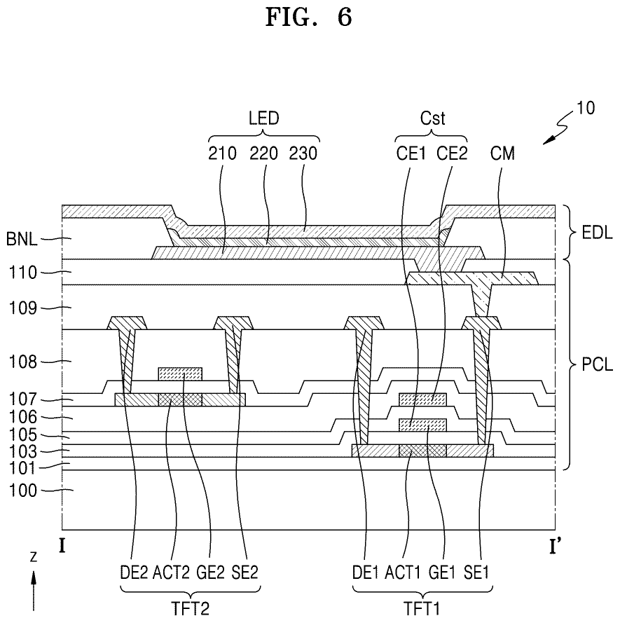

FIG. 6 is a schematic cross-sectional view schematically illustrating a display panel 10 according to an embodiment.

Referring to FIG. 6, the display panel 10 may include a substrate 100, a pixel circuit layer PCL disposed on the substrate 100, and a light-emitting diode layer EDL disposed on the pixel circuit layer PCL.

The substrate 100 may include a glass material, a ceramic material, a metal material, a plastic material, or a flexible or bendable material. The substrate 100 may have a single-layer or multilayer structure including the material described above.

A first insulating layer 101 may be disposed on the substrate 100. The first insulating layer 101 may be a buffer layer that increases a flatness of the upper surface of the substrate 100, or prevents or minimizes infiltration of impurities from the substrate 100 or the like into a semiconductor layer. The first insulating layer 101 may be an inorganic insulating layer including an inorganic insulating material, such as silicon nitride and/or silicon oxide, and may have a single-layer or multilayer structure including the inorganic insulating material described above.

A first thin-film transistor TFT1 may be disposed on the first insulating layer 101. The first thin-film transistor TFT1 may include a first semiconductor layer ACT1, and a first gate electrode GE1, a first source electrode SE1, and a first drain electrode DE1, which are disposed on the first semiconductor layer ACT1. In an embodiment, the first semiconductor layer ACT1 may include a silicon-based semiconductor material.

A second insulating layer 103 may be disposed between the first semiconductor layer ACT1 and the first gate electrode GE1. The second insulating layer 103 may be an inorganic insulating layer including an inorganic insulating material, such as silicon oxide, silicon nitride, and/or silicon oxynitride, and may have a single-layer or multilayer structure including the inorganic insulating material described above.

The first gate electrode GE1 may be disposed on the second insulating layer 103. The first gate electrode GE1 may overlap a channel region of the first semiconductor layer ACT1 in the third direction. In an embodiment, the gate electrode GE1 and the first electrode CE1 of the first capacitor Cst may be integral with each other. The first gate electrode GE1 may include at least one of aluminum (Al), platinum (Pt), palladium (Pd), silver (Ag), magnesium (Mg), gold (Au), nickel (Ni), neodymium (Nd), iridium (Ir), chromium (Cr), lithium (Li), calcium (Ca), molybdenum (Mo), titanium (Ti), tungsten (W), and copper (Cu), and may include a single layer or layers including the material described above.

A third insulating layer 105 may be disposed on the first gate electrode GE1. The third insulating layer 105 may be an inorganic insulating layer including an inorganic insulating material, such as silicon oxide, silicon nitride, and/or silicon oxynitride, and may have a single-layer or multilayer structure including the inorganic insulating material described above.

A second electrode CE2 of the first capacitor Cst may be disposed on the third insulating layer 105. The second electrode CE2 may overlap the first electrode CE1 in the third direction. The first electrode CE1 and the second electrode CE2 may form the first capacitor Cst.

A fourth insulating layer 106 may be disposed on the second electrode CE2. The fourth insulating layer 106 may be an inorganic insulating layer including an inorganic insulating material, such as silicon oxide, silicon nitride, and/or silicon oxynitride, and may have a single-layer or multilayer structure including the inorganic insulating material described above.

A second thin-film transistor TFT2 may be disposed on the fourth insulating layer 106. The second thin-film transistor TFT2 may include a second semiconductor layer ACT2, and a second gate electrode GE2, a second source electrode SE2, and a second drain electrode DE2, which are disposed on the second semiconductor layer ACT2. In an embodiment, the second semiconductor layer ACT2 may include an oxide-based semiconductor material.

A fifth insulating layer 107 may be disposed between the second semiconductor layer ACT2 and the second gate electrode GE2. The fifth insulating layer 107 may be an inorganic insulating layer including an inorganic insulating material, such as silicon oxide, silicon nitride, and/or silicon oxynitride, and may have a single-layer or multilayer structure including the inorganic insulating material described above.

The second gate electrode GE2 may be disposed on the fifth insulating layer 107. The second gate electrode GE2 may overlap a channel region of the second semiconductor layer ACT2 in the third direction. The second gate electrode GE2 may include at least one of aluminum (Al), platinum (Pt), palladium (Pd), silver (Ag), magnesium (Mg), gold (Au), nickel (Ni), neodymium (Nd), iridium (Ir), chromium (Cr), lithium (Li), calcium (Ca), molybdenum (Mo), titanium (Ti), tungsten (W), and copper (Cu), and may include a single layer or layers including the material described above.

A sixth insulating layer 108 may be disposed on the second gate electrode GE2. The sixth insulating layer 108 may be an inorganic insulating layer including an inorganic insulating material, such as silicon oxide, silicon nitride, and/or silicon oxynitride, and may have a single-layer or multilayer structure including the inorganic insulating material described above.

The first source electrode SE1, the first drain electrode DE1, the second source electrode SE2, and the second drain electrode DE2 may be disposed on the sixth insulating layer 108. The first source electrode SE1 and the first drain electrode DE1 may be respectively connected to impurity regions disposed on sides of the channel region of the first semiconductor layer ACT1. The second source electrode SE2 and the second drain electrode DE2 may be respectively connected to impurity regions disposed on sides of the channel region of the second semiconductor layer ACT2. The first source electrode SE1, the first drain electrode DE1, the second source electrode SE2, and the second drain electrode DE2 may each include at least one of aluminum (Al), platinum (Pt), palladium (Pd), silver (Ag), magnesium (Mg), gold (Au), nickel (Ni), neodymium (Nd), iridium (Ir), chromium (Cr), lithium (Li), calcium (Ca), molybdenum (Mo), titanium (Ti), tungsten (W), and copper (Cu), and may include a single layer or layers including the material described above.

A seventh insulating layer 109 may be disposed on the first source electrode SE1, the first drain electrode DE1, the second source electrode SE2, and the second drain electrode DE2. The seventh insulating layer 109 may include an organic insulating material, such as benzocyclobutene (BCB), polyimide, or hexamethyldisiloxane (HMDSO).

A connection electrode CM may be disposed on the seventh insulating layer 109. The connection electrode CM may connect the pixel electrode 210 of the light-emitting diode LED to the first source electrode SE1 through a contact hole passing through the seventh insulating layer 109. The connection electrode CM may include at least one of aluminum (Al), platinum (Pt), palladium (Pd), silver (Ag), magnesium (Mg), gold (Au), nickel (Ni), neodymium (Nd), iridium (Ir), chromium (Cr), lithium (Li), calcium (Ca), molybdenum (Mo), titanium (Ti), tungsten (W), and copper (Cu), and may include a single layer or layers including the material described above.

An eighth insulating layer 110 may be disposed on the connection electrode CM. The eighth insulating layer 110 may include an organic insulating material, such as BCB, polyimide, or HMDSO. The first to eighth insulating layers 101 to 110 and the semiconductor layers and conductive layers disposed between the insulating layers may form the pixel circuit layer PCL.

The light-emitting diode LED may be disposed on the eighth insulating layer 110. The light-emitting diode LED may include a pixel electrode 210 disposed on the eighth insulating layer 110, an opposite electrode 230, and an emission layer 220 between the pixel electrode 210 and the opposite electrode 230.

The pixel electrode 210 may be a reflective electrode. In an embodiment, the pixel electrode 210 may include a reflective layer and a transparent or semitransparent electrode layer disposed on the reflective layer. The reflective layer may include silver (Ag), magnesium (Mg), aluminum (Al), platinum (Pt), palladium (Pd), gold (Au), nickel (Ni), neodymium (Nd), iridium (Ir), chromium (Cr), or a compound thereof. The transparent or semitransparent electrode layer may include at least one of indium tin oxide (ITO), indium zinc oxide (IZO), zinc oxide, indium oxide, indium gallium oxide (IGO), and aluminum zinc oxide (AZO). In an embodiment, the pixel electrode 210 may have a three-layer structure including an ITO layer, an Ag layer, and an ITO layer.

A bank layer BNL may be disposed on the pixel electrodes 210 and cover edges of the pixel electrodes 210. The bank layer BNL may define an opening that exposes the upper surface of each of the pixel electrodes 210. The opening of the bank layer BNL may define an emission area of the light-emitting diode LED. The bank layer BNL may prevent an electric arc or the like from occurring on the edge of the pixel electrode 210 by covering the edge of the pixel electrode 210 and increasing the distance between the edge of the pixel electrode 210 and the opposite electrode 230. The bank layer BNL may include an organic insulating material, such as polyimide, polyamide, an acrylic resin, BCB, HMDSO, or a phenol resin, and may be formed by spin coating.

In some embodiments, the bank layer BNL may include a light-blocking material and may be provided in black. The light-blocking material may include carbon black, carbon nanotubes, a resin or paste including black dye, metal particles (e.g., nickel, aluminum, molybdenum, and an alloy thereof), metal oxide particles (e.g., chromium oxide), or metal nitride particles (e.g., chromium nitride). In case that the bank layer BNL includes a light-blocking material, the reflection of external light due to the metal structures below the bank layer BNL may be reduced.

The emission layer 220 may be patterned to correspond to the pixel electrode 210. The emission layer 220 may include a low molecular weight organic material or a high molecular weight organic material. A first common layer (not shown) and/or a second common layer (not shown) may be respectively disposed below and above the emission layer 220. The first common layer may be disposed below the emission layer 220 and may include a hole transport layer (HTL) or may include an HTL and a hole injection layer (HIL). The second common layer may be disposed above the emission layer 220 and may include an electron transport layer (ETL) and/or an electron injection layer (EIL). In some embodiments, the second common layer may not be provided. The emission layer 220 may be patterned to correspond to the pixel electrode 210, and the first common layer and the second common layer may be integrally formed to completely cover multiple light-emitting diodes LED.

The opposite electrode 230 may be a cathode which is an electron injection electrode. As a material for the opposite electrode 230, a metal, an alloy, an electrically conductive compound, or a combination thereof, which each has a low work function, may be used. The opposite electrode 230 may be a transmissive electrode, a transflective electrode, or a reflective electrode.

The opposite electrode 230 may include lithium (Li), silver (Ag), magnesium (Mg), aluminum (Al), aluminum-lithium (Al—Li), calcium (Ca), magnesium-indium (Mg—In), magnesium-silver (Mg—Ag), ytterbium (Yb), silver-ytterbium (Ag—Yb), ITO, IZO, or a combination thereof. The opposite electrode 230 may have a structure consisting of a layer or a structure including multiple layers.

While the pixel electrode 210 is formed for each light-emitting diode LED, the opposite electrode 230 may be integrally formed across the light-emitting diodes LED. In other words, the light-emitting diodes LED may share the opposite electrode 230 with each other.

In an embodiment, a capping layer (not shown) may be further disposed on the opposite electrode 230. The capping layer may improve external light emission efficiency of the light-emitting diode LED by the principle of constructive interference. The capping layer may include a material having a refractive index greater than or equal to about 1.6 (at 589 nm). The capping layer may be an organic capping layer including an organic material, an inorganic capping layer including an inorganic material, or a composite capping layer including an organic material and an inorganic material.

An encapsulation layer (not shown) may be disposed on the light-emitting diode LED. The encapsulation layer may include at least one inorganic encapsulation layer and at least one organic encapsulation layer. The inorganic encapsulation layer may include silicon oxide, silicon nitride, and/or silicon oxynitride, and the organic encapsulation layer may include an organic insulating material.

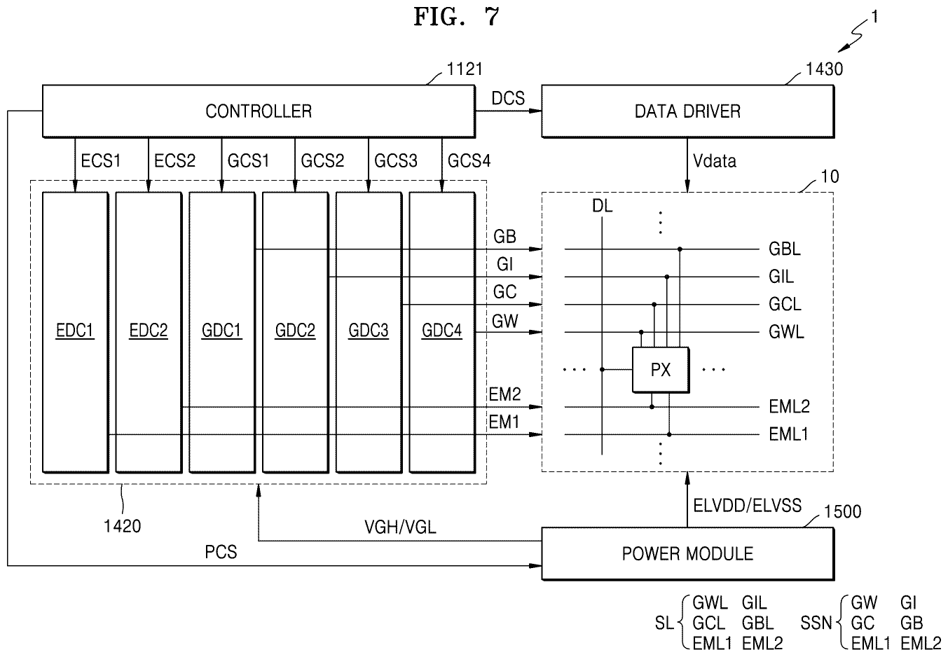

FIG. 7 is a schematic block diagram schematically illustrating an electronic 1 device according to an embodiment.

Referring to FIG. 7, the electronic device 1 according to an embodiment may include a display panel 10, a controller 1121, a scan driver 1420, a data driver 1430, and a power module 1500.

Multiple scan lines SL, multiple data lines DL, and multiple pixels PX connected thereto may be disposed in a display area (see DA of FIG. 4) of the display panel 10. The pixels PX may be repeatedly arranged in a first direction (a row direction) and a second direction (a column direction) intersecting the first direction. The pixels PX may be arranged in various forms, such as a stripe arrangement, a PenTile® arrangement, a Diamond Pentile® arrangement, or a mosaic arrangement, and implement an image. The pixels PX may each include a light-emitting diode (see LED of FIG. 5) and a pixel circuit (see PC of FIG. 5). The pixel circuit PC may include multiple transistors and at least one capacitor. The pixel PX may emit red light, green light, blue light, or white light from the light-emitting diode LED.

The scan lines SL may each extend in the first direction and may be connected to the pixel PX disposed in a same row. The scan lines SL may be configured to transmit scan signals SSN to the pixels PX disposed in a same row. The data lines DL may each extend in the second direction and may be connected to the pixel PX disposed in a same column. The data lines DL may be configured to transmit data signals Vdata to the pixels PX disposed in a same column in synchronization with a first gate signal GW.

The scan driver 1420 may be connected to the scan lines SL and may be configured to generate the scan signals SSN in response to a driving control signal from the controller 1121 and sequentially supply the scan signals SSN to the scan lines SL. The scan lines SL may be connected to gates of transistors included in the pixels PX, and the scan signal SSN may be a gate control signal for controlling turn-on/off of the connected transistors. The scan signal SSN may include a gate-on voltage for turning on the connected transistor and a gate-off voltage for turning off the connected transistor.

In an embodiment, referring to FIG. 5 together, the scan signals SSN may include a first gate signal GW for turning on or off a second transistor T2, a second gate signal GC for turning on or off a third transistor T3 and a fifth transistor T5, a third gate signal GI for turning on or off a fourth transistor T4, a fourth gate signal GB for turning on or off an eighth transistor T8 and a ninth transistor T9, a first emission control signal EM1 for turning on or off a sixth transistor T6, and a second emission control signal EM2 for turning on or off a seventh transistor T7.

The scan lines SL may include a first gate line GWL configured to transmit the first gate signal GW to the pixels PX disposed in a same row, a second gate line GCL configured to transmit the second gate signal GC to the pixels PX disposed in a same row, a third gate line GIL configured to transmit the third gate signal GI to the pixels PX disposed in a same row, a fourth gate line GBL configured to transmit a fourth gate signal GB to the pixels PX disposed in a same row, a first emission control line EML1 configured to transmit the first emission control signal EM1 to the pixels PX disposed in a same row, and a second emission control line EML2 configured to transmit the second emission control signal EM2 to the pixels PX disposed in a same row.

The scan driver 1420 may include an ASG, an LTPS TFT gate driver circuit, or an OSG, which is embedded in the display panel 10.

The scan driver 1420 may include multiple driving circuits. For example, the scan driver 1420 may include a first gate driving circuit GDC1, a second gate driving circuit GDC2, a third gate driving circuit GDC3, a fourth gate driving circuit GDC4, a first emission control driving circuit EDC1, and a second emission control driving circuit EDC2.

The first gate driving circuit GDC1 may be configured to sequentially output the fourth gate signal GB to the fourth gate lines GBL in response to the first gate driving control signal GCS1 from the controller 1121. The second gate driving circuit GDC2 may be configured to sequentially output the third gate signal GI to the third gate lines GIL in response to the second gate driving control signal GCS2 from the controller 1121. The third gate driving circuit GDC3 may be configured to sequentially output the second gate signal GC to the second gate lines GCL in response to the third gate driving control signal GCS3 from the controller 1121. The fourth gate driving circuit GDC4 may be configured to sequentially output the first gate signal GW to the first gate lines GWL in response to the fourth gate driving control signal GCS4 from the controller 1121. The first emission control driving circuit EDC1 may be configured to sequentially output the first emission control signal EM1 to the first emission control lines EML1 in response to the fifth gate driving control signal ECS1 from the controller 1121. The second emission control driving circuit EDC2 may be configured to sequentially output the second emission control signal EM2 to the second emission control lines EML2 in response to the sixth gate driving control signal ECS2 from the controller 1121.

At least two driving circuits having substantially the same or similar circuit configuration among the driving circuits EDC1, EDC2, GDC1, GDC2, GDC3, and GDC4 may be disposed in a same column. In an embodiment, the first emission control driving circuit EDC1 and the second emission control driving circuit EDC2 may be disposed in a same column. The second gate driving circuit GDC2 and the third gate driving circuit GDC3 may be disposed in a same column.

The data driver 1430 may be connected to the data lines DL and may be configured to supply the data signal Vdata to the data lines DL in response to the data driving control signal DCS from the controller 1121. The data signal Vdata supplied to the data lines DL may be supplied to the pixels PX to which the first gate signal GW is supplied. The data driver 1430 may be configured to convert input image data having a gray scale input from the controller 1121 into the data signal Vdata in the form of voltage or current.

The power module 1500 may generate signals VGH and VGL for driving the pixels PX of the display panel 10 in response to a power driving control signal PCS from the controller 1121. In case that the display panel 10 is an organic light-emitting display device, the power module 1500 may generate a first power supply voltage ELVDD and a second power supply voltage ELVSS and supply the first power supply voltage ELVDD and the second power supply voltage ELVSS to the pixels PX. The first power supply voltage ELVDD may be a high level voltage provided to a terminal of the driving transistor (see the first transistor T1 of FIG. 5) connected to the pixel electrode of the light-emitting diode (see LED of FIG. 5) of the pixel PX. The second power supply voltage ELVSS may be a low level voltage provided to the opposite electrode of the light-emitting diode LED. The first power supply voltage ELVDD and the second power supply voltage ELVSS may be driving voltages for allowing the pixels PX to emit light.

The power module 1500 may include a PMIC. The PMIC may be configured to supply optimized power to each component of the electronic device 1.

The controller 1121 may generate the gate driving control signals GCS1, GCS2, GCS3, GCS4, ECS1, and ECS2, the data driving control signal DCS, and the power driving control signal PCS, based on signals input from the outside. The controller 1121 may be configured to supply the gate driving control signals GCS1, GCS2, GCS3, GCS4, ECS1, and ECS2 to the scan driver 1420 and supply the data driving control signal DCS to the data driver 1430. In an embodiment, the gate driving control signals GCS1, GCS2, GCS3, GCS4, ECS1, and ECS2 may each include multiple clock signals and a start signal.

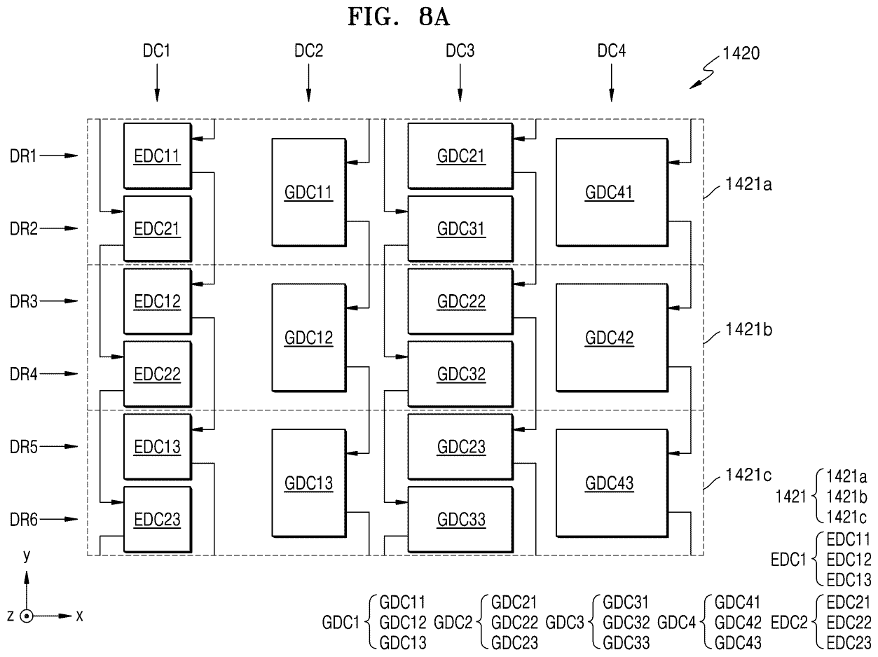

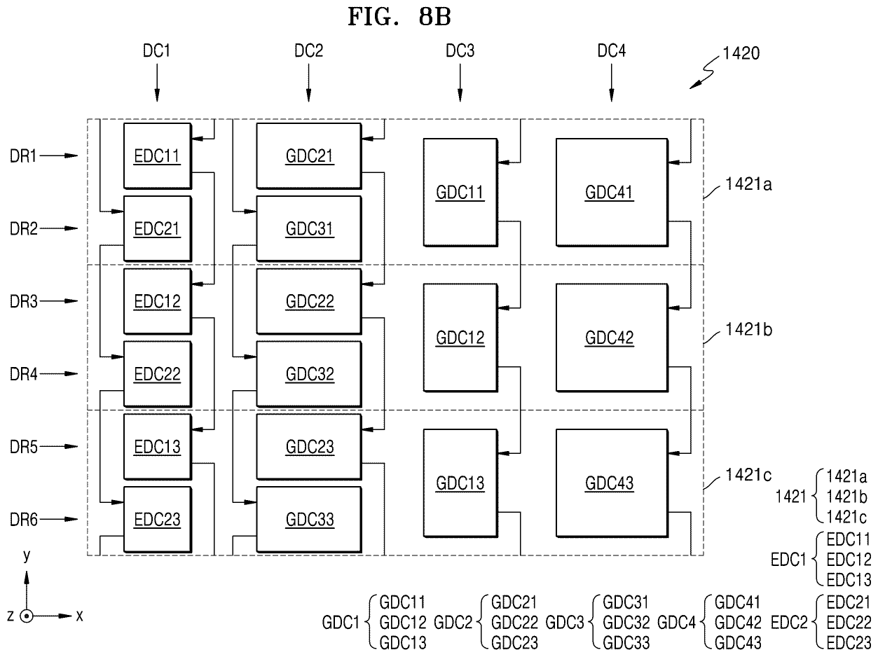

FIGS. 8A and 8B are plan views schematically illustrating the scan driver 1420 according to an embodiment.

FIGS. 8A and 8B schematically illustrate the layout of the driving circuits GDC1, GDC2, GDC3, GDC4, EDC1, and EDC2 included in the scan driver 1420 and the transmission of start signals or carry signals between the stages of the driving circuit GDC1, GDC2, GDC3, GDC4, EDC1, and EDC2.

Referring to FIGS. 8A and 8B, the scan driver 1420 may include a first gate driving circuit GDC1, a second gate driving circuit GDC2, a third gate driving circuit GDC3, a fourth gate driving circuit GDC4, a first emission control driving circuit EDC1, and a second emission control driving circuit EDC2. The first gate driving circuit GDC1, the second gate driving circuit GDC2, the third gate driving circuit GDC3, the fourth gate driving circuit GDC4, the first emission control driving circuit EDC1, and the second emission control driving circuit EDC2 may each include multiple stages. The stages may each be configured to receive at least one clock signal, generate a scan signal, and output the scan signal to a connected output line. The stages may each generate a carry signal and output the carry signal to a subsequent stage. In an embodiment, the carry signal may be an output signal output by a previous stage (hereinafter referred to as a “previous output signal”). The start signal may be input to the first stage among the stages.

The scan driver 1420 may include multiple stage groups each including one stage of each of the first gate driving circuit GDC1, the second gate driving circuit GDC2, the third gate driving circuit GDC3, the fourth gate driving circuit GDC4, the first emission control driving circuit EDC1, and the second emission control driving circuit EDC2. Although FIGS. 8A and 8B illustrate only three stage groups 1421a, 1421b, and 1421c by according to an embodiment, the disclosure is not limited thereto, the number of stage groups 1421 may be more than three.

The first stage group 1421a may include first stages GDC11, GDC21, GDC31, GDC41, EDC11, and EDC21 of the first gate driving circuit GDC1, the second gate driving circuit GDC2, the third gate driving circuit GDC3, the fourth gate driving circuit GDC4, the first emission control driving circuit EDC1, and the second emission control driving circuit EDC2, respectively. The second stage group 1421b may include second stages GDC12, GDC22, GDC32, GDC42, EDC12, and EDC22 of the first gate driving circuit GDC1, the second gate driving circuit GDC2, the third gate driving circuit GDC3, the fourth gate driving circuit GDC4, the first emission control driving circuit EDC1, and the second emission control driving circuit EDC2, respectively. The third stage group 1421c may include third stages GDC13, GDC23, GDC33, GDC43, EDC13, and EDC23 of the first gate driving circuit GDC1, the second gate driving circuit GDC2, the third gate driving circuit GDC3, the fourth gate driving circuit GDC4, the first emission control driving circuit EDC1, and the second emission control driving circuit EDC2, respectively. An n^{th} stage may indicate a stage located at an n^{th} position among the stages included in the driving circuit.

A stage may be connected to at least one scan line (see SL of FIG. 7) configured to transmit a same scan signal (see SSN of FIG. 7). Stages belonging to one stage group 1421 may be electrically connected to the pixel circuits (see PC of FIG. 5) disposed in at least one same pixel circuit row. In an embodiment, the n^{th} stage of each of the driving circuits belonging to the n^{th} stage group 1421 may be electrically connected to pixel circuits PC disposed in a (2n-1)^{th} pixel circuit row and pixel circuits PC disposed in a 2n^{th} pixel circuit row.

For example, the first stages GDC11, GDC21, GDC31, GDC41, EDC11, and EDC21 of the first gate driving circuit GDC1, the second gate driving circuit GDC2, the third gate driving circuit GDC3, the fourth gate driving circuit GDC4, the first emission control driving circuit EDC1, and the second emission control driving circuit EDC2 included in the first stage group 1421a may be electrically connected to pixel circuits PC disposed in a first pixel circuit row and pixel circuits PC disposed in a second pixel circuit row. The second stages GDC12, GDC22, GDC32, GDC42, EDC12, and EDC22 of the first gate driving circuit GDC1, the second gate driving circuit GDC2, the third gate driving circuit GDC3, the fourth gate driving circuit GDC4, the first emission control driving circuit EDC1, and the second emission control driving circuit EDC2 included in the second stage group 1421b may be electrically connected to pixel circuits PC disposed in a third pixel circuit row and pixel circuits PC disposed in a fourth pixel circuit row. The third stages GDC13, GDC23, GDC33, GDC43, EDC13, and EDC23 of the first gate driving circuit GDC1, the second gate driving circuit GDC2, the third gate driving circuit GDC3, the fourth gate driving circuit GDC4, the first emission control driving circuit EDC1, and the second emission control driving circuit EDC2 included in the third stage group 1421c may be electrically connected to pixel circuits PC disposed in a fifth pixel circuit row and pixel circuits PC disposed in a sixth pixel circuit row.

The stages included in one stage group 1421 may be arranged in a matrix in the first direction (the x direction or the row direction) and the second direction (the y direction or the column direction) intersecting the first direction (the x direction). A stage group 1421 may include at least two driving circuit rows. The driving circuit row may be determined based on the stages disposed in the column with the largest number of stages disposed in a same column among the driving circuit columns forming one stage group 1421.

For example, the first stage group 1421a may include a first driving circuit row DR1 and a second driving circuit row DR2. In the first driving circuit row DR1, the first first emission control stage EDC11, the first first gate stage GDC11, the first second gate stage GDC21, and the first fourth gate stage GDC41 may be arranged and spaced apart from each other in the first direction (the x direction). In the second driving circuit row DR2, the first second emission control stage EDC21, the first first gate stage GDC11, the first third gate stage GDC31, and the first fourth gate stage GDC41 may be arranged and spaced apart from each other in the first direction (the x direction). The first first gate stage GDC11 and the first fourth gate stage GDC41 may be disposed across the first driving circuit row DR1 and the second driving circuit row DR2.

The driving circuits GDC1, GDC2, GDC3, GDC4, EDC1, and EDC2 may be spaced apart from each other in the first direction (the x direction). At least two of the driving circuits GDC1, GDC2, GDC3, GDC4, EDC1, and EDC2 may be disposed in a same column. The stages of the driving circuits disposed in a same column may be alternately arranged in the second direction (the y direction).

For example, as illustrated in FIG. 8A, the first emission control stages EDC11, EDC12, EDC13, . . . of the first emission control driving circuit EDC1 and the second emission control stages EDC21, EDC22, EDC23, . . . of the second emission control driving circuit EDC2 may be disposed in the first driving circuit column DC1. The first emission control stages EDC11, EDC12, EDC13, . . . and the second emission control stages EDC21, EDC22, EDC23, . . . may be alternately arranged in the second direction (the y direction). For example, the first emission control stages EDC11, EDC12, EDC13, . . . may be disposed in odd-numbered driving circuit rows DR1, DR3, and DR5, and the second emission control stages EDC21, EDC22, EDC23, . . . may be disposed in even-numbered driving circuit rows DR2, DR4, and DR6. The first gate stages GDC11, GDC12, GDC13, . . . of the first gate driving circuit GDC1 may be sequentially disposed in the second driving circuit column DC2. The second gate stages GDC21, GDC22, GDC23, . . . of the second gate driving circuit GDC2 and the third gate stages GDC31, GDC32, GDC33, . . . of the third gate driving circuit GDC3 may be disposed in the third driving circuit column DC3. The second gate stages GDC21, GDC22, GDC23, . . . and the third gate stages GDC31, GDC32, GDC33, . . . may be alternately arranged in the second direction (the y direction). The second gate stages GDC21, GDC22, GDC23, . . . may be disposed in odd-numbered driving circuit rows DR1, DR3, and DR5, and the third gate stages GDC31, GDC32, GDC33, . . . may be disposed in even-numbered driving circuit rows DR2, DR4, and DR6. The fourth gate stages GDC41, GDC42, GDC43, . . . of the fourth gate driving circuit GDC4 may be disposed in the fourth driving circuit column DC4.

The driving circuits disposed in a same driving circuit column may have substantially identical or similar circuit configurations. For example, the first emission control stages EDC11, EDC12, EDC13, . . . and the second emission control stages EDC21, EDC22, EDC23, . . . may have substantially identical or similar circuit configurations. Similarly, the second gate stages GDC21, GDC22, GDC23, . . . and the third gate stages GDC31, GDC32, GDC33, . . . may have substantially identical or similar circuit configurations. The expression “having substantially identical or similar circuit configurations” may mean that the connection relationship and/or layout of the transistors and capacitors constituting each stage are identical or similar.

In another embodiment, as illustrated in FIG. 8B, the first emission control stages EDC11, EDC12, EDC13, . . . and the second emission control stages EDC21, EDC22, EDC23, . . . may be disposed in the first driving circuit column DC1. The second gate stages GDC21, GDC22, GDC23, . . . and the third gate stages GDC31, GDC32, GDC33, . . . may be disposed in the second driving circuit column DC2. The first gate stages GDC11, GDC12, GDC13, . . . may be sequentially disposed in the third driving circuit column DC3. The fourth gate stages GDC41, GDC42, GDC43, . . . may be disposed in the fourth driving circuit column DC4. However, the disclosure is not limited thereto, and the layout of the first gate driving circuit GDC1, the second gate driving circuit GDC2, the third gate driving circuit GDC3, the fourth gate driving circuit GDC4, the first emission control driving circuit EDC1, and the second emission control driving circuit EDC2 may be variously changed.

Among the stages included in a same driving circuit, the stages disposed after the second stage may receive the previous output signal as a carry signal. For example, the output signal of the first first emission control stage EDC11 may be input to the second first emission control stage EDC12 as a carry signal, and the output signal of the second first emission control stage EDC12 may be input to the third first emission control stage EDC13 as a carry signal. Similarly, the output signal of the first second emission control stage EDC21 may be input to the second second emission control stage EDC22 as a carry signal, and the output signal of the second second emission control stage EDC22 may be input to the third second emission control stage EDC23 as a carry signal.

A first start signal may be input to the first first emission control stage EDC11. A second start signal may be input to the first second emission control stage EDC21. The output timing of the output signal (the first emission control signal EM1 and the second emission control signal EM2) and the width of the output signal (the first emission control signal EM1 and the second emission control signal EM2) may be determined according to a combination of the clock signal, a timing at which the first start signal and the second start signal are input, and the widths of the first start signal and the second start signal.

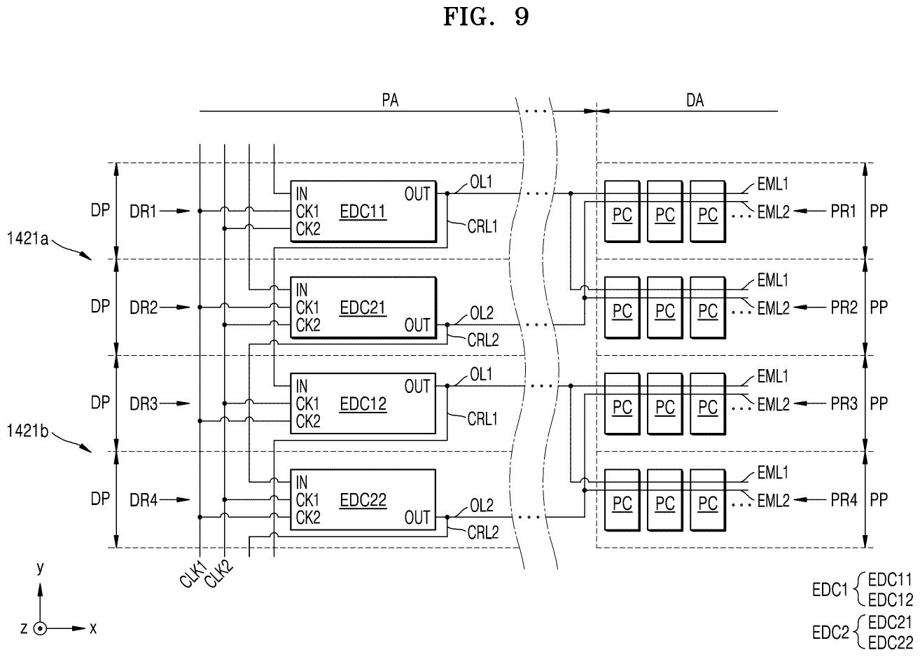

FIG. 9 is a plan view schematically illustrating a first emission control driving circuit and a second emission control driving circuit according to an embodiment.

FIG. 9 schematically illustrates first emission control stages EDC11, EDC12, . . . and second emission control stages EDC21, EDC22, . . . according to an embodiment so as to explain driving circuits alternately disposed in a same driving circuit column. It will be understood by those of ordinary skill in the art that the second gate stages and the third gate stages are disposed in a similar manner.

Referring to FIG. 9, multiple pixel circuits PC may be disposed in a display area DA to form pixel circuit rows PR1, PR2, PR3, PR4, . . . A scan driver 1420 may be disposed in a peripheral area PA. The scan driver 1420 may include multiple driving circuits EDC1, EDC2, . . . . A first emission control driving circuit EDC1 may include multiple first emission control stages EDC11, EDC12, . . . . A second emission control driving circuit EDC2 may include multiple second emission control stages EDC21, EDC22, . . . . The first emission control stages EDC11, EDC12, . . . and the second emission control stages EDC21, EDC22, . . . may be alternately arranged in the second direction (the y direction). For example, the first emission control stages EDC11, EDC12, . . . may be disposed in odd-numbered driving circuit rows DR1 and DR3, and the second emission control stages EDC21, EDC22, . . . may be disposed in even-numbered driving circuit rows DR2 and DR4.

The scan driver 1420 may include multiple stage groups 1421 arranged in the second direction (the y direction). A stage group 1421 may include one stage of the first emission control driving circuit EDC1 and one stage of the second emission control driving circuit EDC2. Therefore, a stage group 1421 may include a pair of an odd-numbered driving circuit row and an even-numbered driving circuit row.

Stages belonging to one stage group 1421 may be electrically connected to the pixel circuits PC disposed in at least one same pixel circuit row. For example, the first first emission control stage EDC11 and the first second emission control stage EDC21 included in the first stage group 1421a may be electrically connected to the pixel circuits PC disposed in the first pixel circuit row PR1 and the pixel circuits PC disposed in the second pixel circuit row PR2. A first output line OL1 connected to an output terminal OUT of the first first emission control stage EDC11 may be connected to the first emission control lines EML1 respectively disposed in the first pixel circuit row PR1 and the second pixel circuit row PR2. A second output line OL2 connected to an output terminal OUT of the first second emission control stage EDC21 may be connected to the second emission control lines EML2 respectively disposed in the first pixel circuit row PR1 and the second pixel circuit row PR2.

The second first emission control stage EDC12 and the second second emission control stage EDC22 included in the second stage group 1421b may be electrically connected to the pixel circuits PC disposed in the third pixel circuit row PR3 and the pixel circuits PC disposed in the fourth pixel circuit row PR4. A first output line OL1 connected to an output terminal OUT of the second first emission control stage EDC12 may be connected to the first emission control lines EML1 respectively disposed in the third pixel circuit row PR3 and the fourth pixel circuit row PR4. A second output line OL2 connected to an output terminal OUT of the second second emission control stage EDC22 may be connected to the second emission control lines EML2 respectively disposed in the third pixel circuit row PR3 and the fourth pixel circuit row PR4.

The first emission control stages EDC11, EDC12, . . . may be configured to output the first emission control signal EM1 to the connected first emission control lines EML1, respectively. The second emission control stages EDC21, EDC22, . . . may be configured to output the second emission control signal EM2 to the connected second emission control lines EML2, respectively.

The emission control stages EDC11, EDC12, EDC21, EDC22, . . . may each include an input terminal IN, a first clock terminal CK1, a second clock terminal CK2, and an output terminal OUT. Each of the first clock terminal CK1 and the second clock terminal CK2 may be connected to one of the clock lines to which the clock signal is input. The clock lines may include a first clock line CLK1 to which a first clock signal is input and a second clock line CLK2 to which a second clock signal is input. The first clock signal and the second clock signal may be square wave signals that repeat a high level voltage and a low level voltage. The first clock signal and the second clock signal may be signals with a same waveform, a same period, and a shifted phase (a delayed phase).

The first clock terminal CK1 and the second clock terminal CK2 of one stage may be connected to different clock lines. For example, the first clock terminal CK1 of each of the first emission control stages EDC11, EDC12, . . . may be alternately connected to one of the first clock line CLK1 and the second clock line CLK2, and the second clock terminal CK2 of each of the first emission control stages EDC11, EDC12, . . . may be alternately connected to one of the second clock line CLK2 and the first clock line CLK1. The first clock terminal CK1 of each of the second emission control stages EDC21, EDC22, . . . may be alternately connected to one of the first clock line CLK1 and the second clock line CLK2, and the second clock terminal CK2 of each of the second emission control stages EDC21, EDC22, . . . may be alternately connected to one of the second clock line CLK2 and the first clock line CLK1.

For example, the first clock terminal CK1 of the first first emission control stage EDC11 may be connected to the first clock line CLK1, and the second clock terminal CK2 of the first first emission control stage EDC11 may be connected to the second clock line CLK2. For example, the first clock terminal CK1 of the first second emission control stage EDC21 may be connected to the second clock line CLK2, and the second clock terminal CK2 of the first second emission control stage EDC21 may be connected to the first clock line CLK1. The first clock terminal CK1 of the second first emission control stage EDC12 may be connected to the second clock line CLK2, and the second clock terminal CK2 of the second first emission control stage EDC12 may be connected to the first clock line CLK1. The first clock terminal CK1 of the second second emission control stage EDC22 may be connected to the second clock line CLK2, and the second clock terminal CK2 of the second second emission control stage EDC22 may be connected to the first clock line CLK1.

Although FIG. 9 illustrates that the first emission control stages EDC11, EDC12, . . . and the second emission control stages EDC21, EDC22, . . . are connected to the two clock lines CLK1 and CLK2, the disclosure is not limited thereto. In another embodiment, the number of clock lines and the number of clock signals may more than two. For example, the clock lines may include a first clock line configured to transmit the first clock signal, a second clock line configured to transmit a second clock, a third clock line configured to transmit a third clock, and a fourth clock line configured to transmit a fourth clock signal.

The first start signal may be input to the input terminal IN of the first first emission control stage EDC11 among the first emission control stages EDC11, EDC12, . . . . The output signal of the previous stage (e.g., the first emission control stage located at the (n-1)^{th} position), i.e., the first emission control signal EM1, may be input to the input terminal IN of each of the stages (e.g., the first emission control stage located at the n^{th} position, where 2≤n) after the second first emission control stage EDC12.

For example, first carry signal lines CRL1 may be configured to connect the input terminal IN of one stage (e.g., the second first emission control stage EDC12) of the first emission control driving circuit EDC1 to the output terminal OUT of the previous stage (e.g., the first first emission control stage EDC11). The output signal of the first first emission control stage EDC11 may be input to the input terminal IN of the second first emission control stage EDC12 as a carry signal.

Second carry signal lines CRL2 may be configured to connect the input terminal IN of one stage (e.g., the n^{th} second emission control stage) of the second emission control driving circuit EDC2 to the output terminal OUT of the previous stage (e.g., the (n-1)^{th} emission control stage). The output signal of the first second emission control stage EDC21, i.e., the second emission control signal EM2, may be input to the input terminal IN of the second second emission control stage EDC22 as a carry signal.

The first carry signal lines CRL1 may be configured to connect the first emission control stages EDC11, EDC12, . . . disposed in the odd-numbered driving circuit rows DR1, DR3, . . . and the second carry signal lines CRL2 may be configured to connect the second emission control stages EDC21, EDC22, . . . disposed in the even-numbered driving circuit rows DR2, DR4, . . . . Therefore, in a plan view, the first carry signal line CRL1 and the second carry signal line CRL2 may intersect each other. The first carry signal line CRL1 and the second carry signal line CRL2 may be disposed on different layers in an area where the first carry signal line CRL1 and the second carry signal line CRL2 intersect each other, so as to be electrically isolated from each other. In the area where the first carry signal line CRL1 and the second carry signal line CRL2 intersect each other, at least one insulating layer may be disposed between the first carry signal line CRL1 and the second carry signal line CRL2.

In an embodiment, the width of each of the first emission control stages EDC11, EDC12, . . . in the second direction (the y direction) and the width of each of the second emission control stages EDC21, EDC22, . . . in the second direction (the y direction) may be equal to a first width DP. The first width DP may be a spacing between the stages adjacent to each other in the second direction (the y direction). The width of one stage group 1421 in the second direction (the y direction) may be twice the first width DP.

The width of the pixel circuit PC in the second direction (the y direction) may be a second width PP. The second width PP may be a spacing between the pixel circuits PC adjacent to each other in the second direction (the y direction). In an embodiment, the first width DP may be equal to the second width PP.

Although FIG. 9 illustrates that the centers of the driving circuit rows and the pixel circuit rows are disposed on a same virtual straight line in the first direction (the x direction), the disclosure is not limited thereto. In another embodiment, the pixel circuit rows corresponding to one driving circuit row may be shifted by a distance in the second direction (the y direction).

Because the two driving circuits EDC1 and EDC2 configured to output different scan signals are disposed in a same driving circuit column, the width of the scan driver 1420 in the first direction (the x direction) may be reduced. Therefore, the display panel 10 according to an embodiment may reduce dead space, which is an area where an image is not displayed.

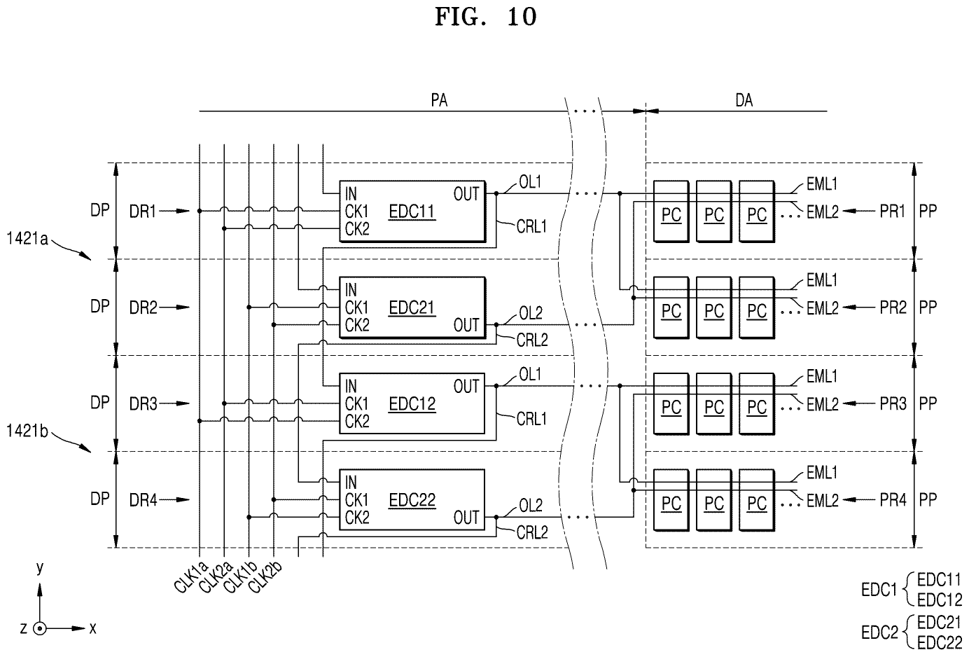

FIG. 10 is a plan view schematically illustrating a first emission control driving circuit and a second emission control driving circuit according to an embodiment.

FIG. 10 is similar to FIG. 9, but illustrates an embodiment that clock signals transmitted to a first clock terminal CK1 and a second clock terminal CK2 of a first emission control driving circuit EDC1 are different from clock signals transmitted to a first clock terminal CK1 and a second clock terminal CK2 of a second emission control driving circuit EDC2. Hereinafter, the identical or similar description is omitted and the differences are described.

Multiple stages EDC11, EDC12, EDC21, EDC22, . . . may each include an input terminal IN, a first clock terminal CK1, a second clock terminal CK2, and an output terminal OUT. Each of the first clock terminal CK1 and the second clock terminal CK2 may be connected to one of the clock lines to which a clock signal is input. The clock lines may include a first-1 clock line CLK1a to which a first-1 clock signal is input, a second-1 clock line CLK2a to which a second-1 clock signal is input, a first-2 clock line CLK1b to which a first-2 clock signal is input, and a second-2 clock line CLK2b to which a second-2 clock signal is input. The first-1 clock signal, the second-1 clock signal, the first-2 clock signal, and the second-2 clock signal may each be a square wave signal that repeats a high level voltage and a low level voltage. The first-1 clock signal and the second-1 clock signal may be signals with a same waveform, a same period, and a shifted phase. The first-2 clock signal and the second-2 clock signal may be signals with a same waveform, a same period, and a shifted phase.

The first clock terminal CK1 and the second clock terminal CK2 of one stage may be connected to different clock lines. The first clock terminal CK1 of each of the first emission control stages EDC11, EDC12, . . . may be alternately connected to one of the first-1 clock line CLK1a and the second-1 clock line CLK2a, and the second clock terminal CK2 of each of the first emission control stages EDC11, EDC12, . . . may be alternately connected to one of the second-1 clock line CLK2a and the first-1 clock line CLK1a. For example, the first clock terminal CK1 of the first first emission control stage EDC11 may be connected to the first-1 clock line CLK1a, and the second clock terminal CK2 of the first first emission control stage EDC11 may be connected to the second-1 clock line CLK2a. The first clock terminal CK1 of the second first emission control stage EDC12 may be connected to the second-1 clock line CLK2a, and the second clock terminal CK2 of the second first emission control stage EDC12 may be connected to the first-1 clock line CLK1a.

The first clock terminal CK1 of each of the second emission control stages EDC21, EDC22, . . . may be alternately connected to one of the first-2 clock line CLK1b and the second-2 clock line CLK2b, and the second clock terminal CK2 of each of the second emission control stages EDC21, EDC22,. may be alternately connected to one of the second-2 clock line CLK2b and the first-2 clock line CLK1b. For example, the first clock terminal CK1 of the first second emission control stage EDC21 may be connected to the first-2 clock line CLK1b, and the second clock terminal CK2 of the first second emission control stage EDC21 may be connected to the second-2 clock line CLK2b. The first clock terminal CK1 of the second second emission control stage EDC22 may be connected to the second-2 clock line CLK2b, and the second clock terminal CK2 of the second second emission control stage EDC22 may be connected to the first-2 clock line CLK1b.

Although FIG. 10 illustrates that the first emission control stages EDC11, EDC12, . . . are connected to the two clock signal lines CLK1a and CLK2a and the second emission control stages EDC21, EDC22, . . . are connected to the two clock signal lines CLK1b and CLK2b, the disclosure is not limited thereto. In another embodiment, the number of clock signal lines and the number of clock signals connected to each driving circuit may be more than two.

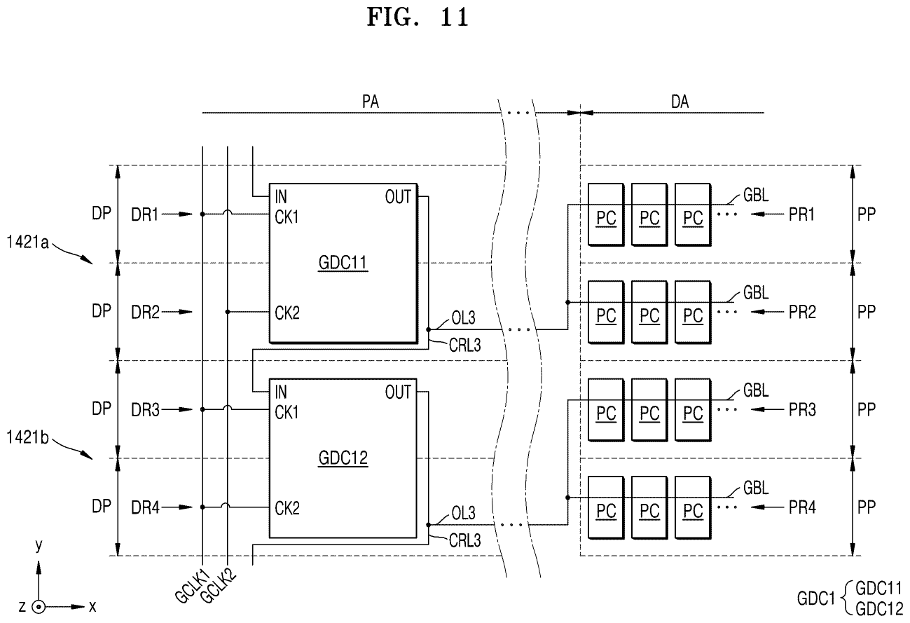

FIG. 11 is a plan view schematically illustrating a first gate driving circuit according to an embodiment.

FIG. 11 schematically illustrates first gate stages GDC11, GDC12, . . . according to an embodiment so as to explain driving circuits overlap two driving circuit columns in the third direction. It will be understood by those of ordinary skill in the art that the stages of the fourth gate driving circuit (see GDC4 of FIG. 8A) are disposed in a similar manner.

Referring to FIG. 11, multiple pixel circuits PC may be disposed in a display area DA to form pixel circuit rows PR1, PR2, PR3, PR4, . . . . A scan driver 1420 may be disposed in a peripheral area PA. The scan driver 1420 may include a first gate driving circuit GDC1. The first gate driving circuit GDC1 may include multiple first gate stages GDC11, GDC12, . . . . The first gate stages GDC11, GDC12, . . . may be disposed in the second direction (the y direction). The first first gate stage GDC11 may overlap a first driving circuit row DR1 and a second driving circuit row DR2, and the second first gate stage GDC12 may overlap a third driving circuit row DR3 and a fourth driving circuit row DR4 in the third direction.

The scan driver 1420 may include multiple stage groups 1421 disposed in the second direction (the y direction). A stage group 1421 may include one stage of the first gate driving circuit GDC1.

The first first gate stage GDC11 included in the first stage group 1421a may be electrically connected to pixel circuits PC disposed in the first pixel circuit row PR1 and the second pixel circuit row PR2. A third output line OL3 connected to an output terminal OUT of the first first gate stage GDC11 may be connected to fourth gate lines GBL respectively disposed in the first pixel circuit row PR1 and the second pixel circuit row PR2.

The second first gate stage GDC12 included in the second stage group 1421b may be electrically connected to pixel circuits PC disposed in the third pixel circuit row PR3 and the fourth pixel circuit row PR4. A third output line OL3 connected to an output terminal OUT of the second first gate stage GDC12 may be connected to fourth gate lines GBL respectively disposed in the third pixel circuit row PR3 and the fourth pixel circuit row PR4. The first gate stages GDC11, GDC12, . . . may be configured to output a fourth gate signal GB to the connected fourth gate lines GBL, respectively.

The first gate stages GDC11, GDC12, . . . may each include an input terminal IN, a first clock terminal CK1, a second clock terminal CK2, and an output terminal OUT. Each of the first clock terminal CK1 and the second clock terminal CK2 may be connected to one of the clock lines to which the clock signal is input. The clock lines may include a first gate clock line GCLK1 to which a first gate clock signal is input and a second gate clock line GCLK2 to which a second gate clock signal is input. The first gate clock signal and the second gate clock signal may be square wave signals that repeat a high level voltage and a low level voltage. The first gate clock signal and the second gate clock signal may be signals with a same waveform, a same period, and a shifted phase.

The first clock terminal CK1 and the second clock terminal CK2 of one stage may be connected to different clock lines. For example, the first clock terminal CK1 of each of the first gate stages GDC11, GDC12, . . . may be alternately connected to one of the first gate clock line GCLK1 and the second gate clock line GCLK2, and the second clock terminal CK2 of each of the first gate stages GDC11, GDC12, . . . may be alternately connected to one of the second gate clock line GCLK2 and the first gate clock line GCLK1. For example, the first clock terminal CK1 of the first gate stage GDC11 may be connected to the first gate clock line GCLK1, and the second clock terminal CK2 of the first gate stage GDC11 may be connected to the second gate clock line GCLK2. The first clock terminal CK1 of the second first gate stage GDC12 may be connected to the second gate clock line GCLK2, and the second clock terminal CK2 of the second first gate stage GDC12 may be connected to the first gate signal GC.

Although FIG. 11 illustrates that the first gate driving circuit GDC1 is connected to the two clock lines GCLK1 and GCLK2, the disclosure is not limited thereto. In another embodiment, the number of clock lines and the number of clock signals may be more than two.

A first start signal may be input to the input terminal IN of the first first gate stage GDC11 among the first gate stages GDC11, GDC12, . . . . The output signal of the previous stage, i.e., the fourth gate signal GB, may be input to the input terminal IN of each stage after the second first gate stage GDC12 among the first gate stages GDC11, GDC12, . . . .

For example, third carry signal lines CRL3 may be configured to connect the input terminal IN of one stage of the first gate driving circuit GDC1 to the output terminal OUT of the previous stage. The output signal of the first first gate stage GDC11 may be input to the input terminal IN of the second first gate stage GDC12 as a carry signal.

In an embodiment, the width of one stage group 1421 in the second direction (the y direction) may be twice the first width DP. For example, the width of each of the first gate stages GDC11, GDC12, . . . in the second direction (the y direction) may be twice the first width DP. The width of the pixel circuit PC in the second direction (the y direction) may be a second width PP. In an embodiment, the first width DP may be equal to the second width PP.

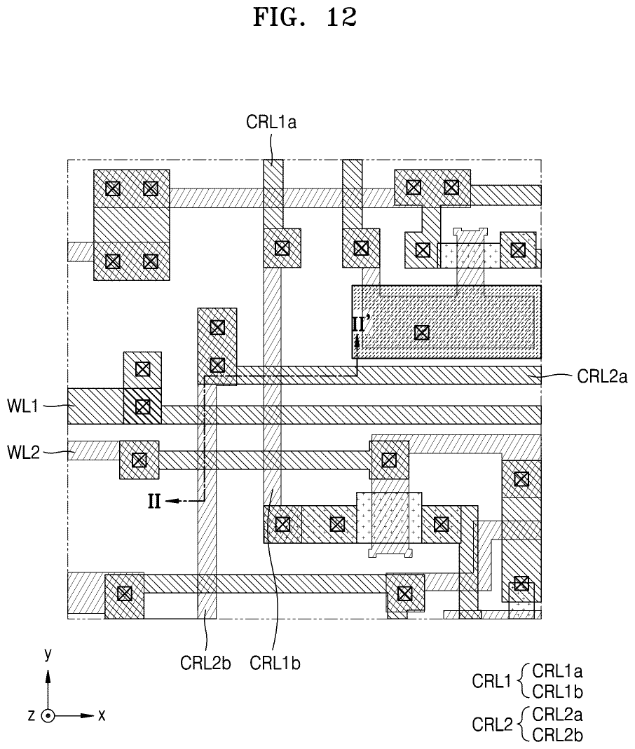

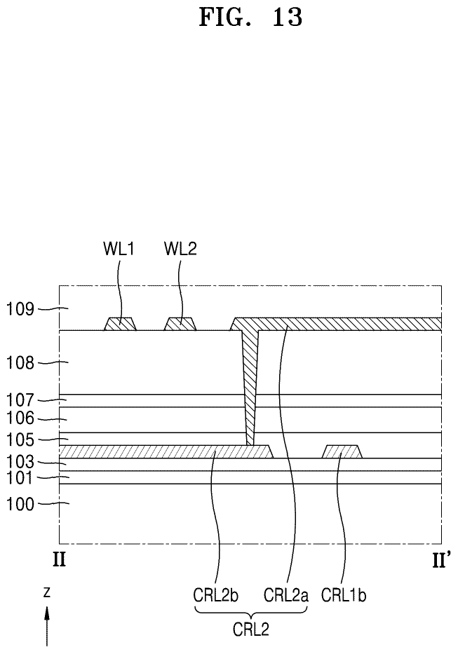

FIG. 12 is a plan view schematically illustrating carry signal lines according to an embodiment, and FIG. 13 is a schematic cross-sectional view schematically illustrating the carry signal lines according to an embodiment.

Referring to FIG. 12, a first carry signal line CRL1 and a second carry signal line CRL2 may be disposed on a substrate 100. The first carry signal line CRL1 may be configured to connect the input terminal IN of one stage of the first emission control driving circuit EDC1 to the output terminal OUT of the previous stage. The second carry signal line CRL2 may be configured to connect the input terminal IN of one stage of the second emission control driving circuit EDC2 to the output terminal OUT of the previous stage.

In a plan view, the first carry signal line CRL1 and the second carry signal line CRL2 may intersect each other. For example, the first carry signal line CRL1 may include a first sub-carry signal line CRL1a extending in the second direction (the y direction) and a second sub-carry signal line CRL1b electrically connected to the first sub-carry signal line CRL1a. The second carry signal line CRL2 may include a third sub-carry signal line CRL2a extending in the first direction (the x direction) and a fourth sub-carry signal line CRL2b extending in the second direction (the y direction) and electrically connected to the third sub-carry signal line CRL2a.

In a plan view, the second sub-carry signal line CRL1b and the third sub-carry signal line CRL2a may intersect each other. To electrically isolate the first carry signal line CRL1 from the second carry signal line CRL2, the second sub-carry signal line CRL1b and the third sub-carry signal line CRL2a may be disposed on different conductive layers. At least one insulating layer may be disposed between the second sub-carry signal line CRL1b and the third sub-carry signal line CRL2a.

In an embodiment, signal lines WL1 and WL2 extending in the first direction (the x direction) may be further disposed on the substrate 100. The signal lines WL1 and WL2 may each be a line configured to transmit a voltage or a clock signal to a corresponding stage. In a plan view, the second sub-carry signal line CRL1b and the fourth sub-carry signal line CRL2b may intersect the signal lines WL1 and WL2. To electrically isolate the second sub-carry signal line CRL1b and the fourth sub-carry signal line CRL2b from the signal lines WL1 and WL2, a conductive layer on which the second sub-carry signal line CRL1b and the fourth sub-carry signal line CRL2b are disposed may be different from a conductive layer on which the signal lines WL1 and WL2 are disposed. In an embodiment, the signal lines WL1 and WL2 and the third sub-carry signal line CRL2a may be disposed on a same conductive layer.

Referring to FIG. 13, the fourth sub-carry signal line CRL2b and the second sub-carry signal line CRL1b may be disposed between a second insulating layer 103 and a third insulating layer 105. The fourth sub-carry signal line CRL2b, the second sub-carry signal line CRL1b, and the gate electrode GE1 of the first thin-film transistor TFT1 illustrated in FIG. 6 may be disposed on a same layer.

The third sub-carry signal line CRL2a and the signal lines WL1 and WL2 may be disposed between a sixth insulating layer 108 and a seventh insulating layer 109. The third sub-carry signal line CRL2a, the signal lines WL1 and WL2, the source electrode SE1, and the drain electrode DE1 of the first thin-film transistor TFT1 may be disposed on a same layer.

The third sub-carry signal line CRL2a and the fourth sub-carry signal line CRL2b may be connected to each other through a contact hole passing through the third to sixth insulating layers 105 to 108. In a plan view, a portion of the third sub-carry signal line CRL2a may overlap a portion of the second sub-carry signal line CRL1b. However, the third to sixth insulating layers 105 to 108 may be disposed between the third sub-carry signal line CRL2a and the second sub-carry signal line CRL1b, and thus, the third sub-carry signal line CRL2a and the second sub-carry signal line CRL1b may be electrically isolated from each other. In a plan view, a portion of the signal lines WL1 and WL2 may overlap a portion of the fourth sub-carry signal line CRL2b. However, the third to sixth insulating layers 105 to 108 may be disposed between the signal lines WL1 and WL2 and the fourth sub-carry signal line CRL2b, and thus, the signal lines WL1 and WL2 and the fourth sub-carry signal line CRL2b may be electrically isolated from each other.

Although FIGS. 12 and 13 illustrate that the first sub-carry signal line CRL1a and the third sub-carry signal line CRL2a are disposed between the sixth insulating layer 108 and the seventh insulating layer 109 and the second sub-carry signal line CRL1b and the fourth sub-carry signal line CRL2b are disposed between the second insulating layer 103 and the third insulating layer 105, the disclosure is not limited thereto. The first sub-carry signal line CRL1a and the third sub-carry signal line CRL2a may be disposed on one of the conductive layers included in the pixel circuit layer (see PCL of FIG. 6), and the second sub-carry signal line CRL1b and the fourth sub-carry signal line CRL2b may be disposed on another one of the conductive layers included in the pixel circuit layer PCL.

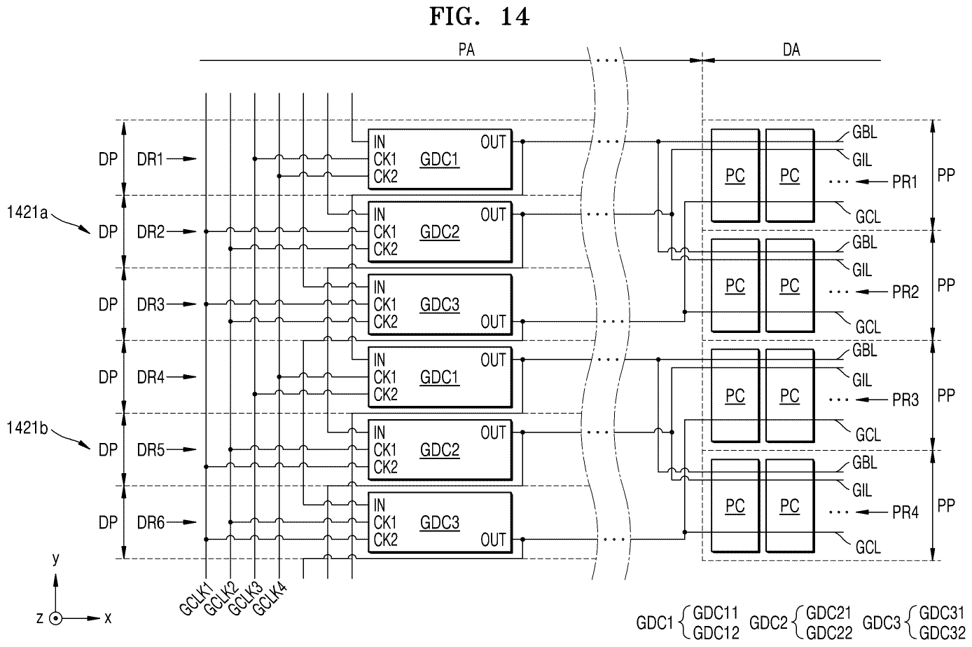

FIG. 14 is a plan view schematically illustrating the layout of driving circuits according to an embodiment.

Referring to FIG. 14, multiple pixel circuits PC may be disposed in a display area DA to form pixel circuit rows PR1, PR2, PR3, PR4, . . . . A scan driver 1420 may be disposed in a peripheral area PA. The scan driver 1420 may include multiple driving circuits GDC1, GDC2, GDC3, . . . FIG. 14 schematically illustrates a first gate driving circuit GDC1, a second gate driving circuit GDC2, and a third gate driving circuit GDC3 among the driving circuits GDC1, GDC2, GDC3, . . . according to an embodiment.

The first gate driving circuit GDC1, the second gate driving circuit GDC2, and the third gate driving circuit GDC3 may each include multiple stages. In an embodiment, first gate stages GDC11, GDC12, . . . second gate stages GDC21, GDC22, . . . and third gate stages GDC31, GDC32, . . . may be repeatedly arranged in the second direction (the y direction). For example, the first gate stages GDC11, GDC12, . . . may be disposed in (3i-2)^{th} driving circuit rows DR1, DR4, . . . the second gate stages GDC21, GDC22, . . . may be disposed in (3i-1)^{th} driving circuit rows DR2, DR5, . . . and the third gate stages GDC31, GDC32, . . . may be disposed in 3i^{th} driving circuit rows DR3, DR6, . . . i may be a natural number greater than or equal to 1.

The scan driver 1420 may include multiple stage groups 1421 disposed in the second direction (the y direction). A stage group 1421 may include multiple consecutive driving circuit rows. In an embodiment, a stage group 1421 may include three consecutive driving circuit rows. For example, a first stage group 1421a may include the first to third driving circuit rows DR1, DR2, and DR3, and a second stage group 1421b may include the fourth to sixth driving circuit rows DR4, DR5, and DR6.

Stages belonging to one stage group 1421 may be electrically connected to the pixel circuits PC disposed in at least one same pixel circuit row. For example, the first first gate stage GDC11, the first second gate stage GDC21, and the first third gate stage GDC31 included in the first stage group 1421a may be electrically connected to the pixel circuits PC disposed in the first pixel circuit row PR1 and the second pixel circuit row PR2.

For example, the output terminal OUT of the first first gate stage GDC11 may be connected to the fourth gate lines GBL disposed in the first pixel circuit row PR1 and the second pixel circuit row PR2 through the output line. The output terminal OUT of the first second gate stage GDC21 may be connected to the third gate lines GIL disposed in the first pixel circuit row PR1 and the second pixel circuit row PR2 through the output line. The output terminal OUT of the first third gate stage GDC31 may be connected to the second gate lines GCL disposed in the first pixel circuit row PR1 and the second pixel circuit row PR2 through the output line.

Similarly, the second first gate stage GDC12, the second second gate stage GDC22, and the second third gate stage GDC32 included in the second stage group 1421b may be electrically connected to the pixel circuits PC disposed in the third pixel circuit row PR3 and the fourth pixel circuit row PR4.

The first gate stages GDC11, GDC12, . . . may be configured to output a fourth gate signal GB to the connected fourth gate lines GBL, respectively. The second gate stages GDC21, GDC22, . . . may be configured to output a third gate signal GI to the connected third gate lines GIL, respectively. The third gate stages GDC31, GDC32, . . . may be configured to output a second gate signal GC to the connected second gate lines GCL, respectively.

Multiple stages GDC11, GDC12, GDC21, GDC22, GDC31, GDC32, . . . may each include an input terminal IN, a first clock terminal CK1, a second clock terminal CK2, and an output terminal OUT. Each of the first clock terminal CK1 and the second clock terminal CK2 may be connected to one of the clock lines to which the clock signal is input.

The clock lines may include a first gate clock line GCLK1 to which a first gate clock signal is input, a second gate clock line GCLK2 to which a second gate clock signal is input, a third gate clock line GCLK3 to which a third gate clock signal is input, and a fourth gate clock line GCLK4 to which a fourth gate clock signal is input.

The first to fourth gate clock signals may be square wave signals that repeat a high level voltage and a low level voltage. The first gate clock signal and the second gate clock signal may be signals with a same waveform, a same period, and a shifted phase. The third gate clock signal and the fourth gate clock signal may be signals with a same waveform, a same period, and a shifted phase.

The first clock terminal CK1 and the second clock terminal CK2 of one stage may be connected to different clock lines. For example, the first clock terminal CK1 of each of the first gate stages GDC11, GDC12, . . . may be alternately connected to one of the third gate clock line GCLK3 and the fourth gate clock line GCLK4, and the second clock terminal CK2 of each of the first gate stages GDC11, GDC12, . . . may be alternately connected to one of the fourth gate clock line GCLK4 and the third gate clock line GCLK3. The first clock terminal CK1 of each of the second gate stages GDC21, GDC22, . . . may be alternately connected to one of the first gate clock line GCLK1 and the second gate clock line GCLK2, and the second clock terminal CK2 of each of the second gate stages GDC21, GDC22, . . . may be alternately connected to one of the second gate clock line GCLK2 and the first gate clock line GCLK1. The first clock terminal CK1 of each of the third gate stages GDC31, GDC32, . . . may be alternately connected to one of the first gate clock line GCLK1 and the second gate clock line GCLK2, and the second clock terminal CK2 of each of the third gate stages GDC31, GDC32, . . . may be alternately connected to one of the second gate clock line GCLK2 and the first gate clock line GCLK1.

A first gate start signal may be input to the input terminal IN of the first first gate stage GDC11. The output signal of the previous stage (e.g., the first gate stage located at the (n-1)^{th} position) may be input to the input terminal IN of each of the stages (e.g., the first gate stage located at the n^{th} position, where 2≤n) after the second first gate stage GDC12.

A second gate start signal may be input to the input terminal IN of the first second gate stage GDC21. The output signal of the previous stage (e.g., the second gate stage located at the (n-1)^{th} position) may be input to the input terminal IN of each of the stages (e.g., the second gate stage located at the n^{th} position, where 2≤n) after the second second gate stage GDC22.

A third gate start signal may be input to the input terminal IN of the first third gate stage GDC31. The output signal of the previous stage (e.g., the third gate stage located at the (n-1)^{th} position) may be input to the input terminal IN of each of the stages (e.g., the third gate stage located at the n^{th} position, where 2≤n) after the second third gate stage GDC32.

In a plan view, carry signal lines connected to the first gate stages GDC11, GDC12, . . . may intersect carry signal lines connected to the second gate stages GDC21, GDC22, . . . and carry signal lines connected to the third gate stages GDC31, GDC32, . . . . The carry signal lines connected to different driving circuits may be disposed on different conductive layers in an area where the carry signal lines intersect each other, and may be electrically isolated from each other.

In an embodiment, the width of the stages disposed in the second direction (the y direction) and the width of the pixel circuits PC disposed in the second direction (the y direction) may be different from each other. In an embodiment, the width of each of the first gate stages GDC11, GDC12, . . . the second gate stages GDC21, GDC22, . . . and the third gate stages GDC31, GDC32, . . . in the second direction (the y direction) may be equal to the first width DP. The width of the pixel circuit PC in the second direction (the y direction) may be a second width PP. In an embodiment, k times the first width DP may be l times the second width PP. k and l may be different natural numbers.

In an embodiment, as illustrated in FIG. 14, three times the first width DP may be equal to two times the second width PP. The width of one stage group 1421 may be three times the first width DP in the second direction (the y direction).

The number of pixel circuit rows connected to one stage group 1421 may be two. In an embodiment, the first gate stage located at the i^{th} position among the first gate stages GDC11, GDC12, . . . may be configured to output a fourth gate signal GB to the pixel circuits PC disposed in the (2i-1)^{th} row and the pixel circuits PC disposed in the 2i^{th} row among the pixel circuits PC, the second gate stage located at the i^{th} position among the second gate stages GDC21, GDC22, . . . may be configured to output a third gate signal GI to the pixel circuits PC disposed in the (2i-1)^{th} row and the pixel circuits PC disposed in the 2i^{th} row among the pixel circuits PC, and the third gate stage located at the i^{th} position among the third gate stages GDC31, GDC32, . . . may be configured to output a second gate signal GC to the pixel circuits PC disposed in the (2i-1)^{th} row and the pixel circuits PC disposed in the 2i^{th} row among the pixel circuits PC. i may be a natural number greater than or equal to 1.

Although FIG. 14 illustrates that the first gate driving circuit GDC1, the second gate driving circuit GDC2, and the third gate driving circuit GDC3 are disposed in a same column according to an embodiment, the disclosure is not limited thereto. In another embodiment, the second gate driving circuit GDC2, the third gate driving circuit GDC3, and the fourth gate driving circuit GDC4 may be disposed in a same column.

Because the driving circuits GDC1, GDC2, and GDC3 configured to output different scan signals are disposed in a same driving circuit column, the width of the scan driver 1420 in the first direction (the x direction) may be reduced. Therefore, the display panel 10 according to an embodiment may reduce dead space, which is an area where an image is not displayed.

According to embodiments, a display panel with an expanded display area and an electronic device including the display panel may be implemented. The scope of the disclosure is not limited by such an effect.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A display panel comprising:
a plurality of pixel circuits disposed in a display area; and
a scan driver disposed in a peripheral area adjacent to the display area and comprising a first driving circuit and a second driving circuit, wherein the first driving circuit comprises a plurality of first stages that output first scan signals to the plurality of pixel circuits,
the second driving circuit comprises a plurality of second stages that output second scan signals to the plurality of pixel circuits,
the plurality of first stages are disposed in odd-numbered rows, and
the plurality of second stages are disposed in even-numbered rows.

2. The display panel of claim 1, further comprising:
a first carry signal line that connects an input terminal of a first stage located at an n^{th} position among the plurality of first stages to an output terminal of a first stage located at an (n-1)^{th} position among the plurality of first stages; and
a second carry signal line that connects an input terminal of a second stage located at an n^{th} position among the plurality of second stages to an output terminal of a second stage located at an (n-1)^{th} position among the plurality of second stages,
wherein n is a natural number greater than or equal to 2.

3. The display panel of claim 2, wherein, in a plan view, the first carry signal line intersects the second carry signal line.

4. The display panel of claim 3, wherein the first carry signal line and the second carry signal line are disposed on different layers in an area where the first carry signal line and the second carry signal line intersect each other.

5. The display panel of claim 2, wherein
a first start signal is input to an input terminal of a first stage located at a first position among the plurality of first stages, and
a second start signal that is different from the first start signal is input to an input terminal of a second stage located at a first position among the plurality of second stages.

6. The display panel of claim 5, wherein
a first scan signal output by the first stage located at the (n-1)^{th} position is input to the input terminal of the first stage located at the n^{th} position among the plurality of first stages, and
a second scan signal output by the second stage located at the (n-1)^{th} position is input to the input terminal of the second stage located at the n^{th} position among the plurality of second stages.

7. The display panel of claim 1, further comprising:
clock lines connected to the scan driver, wherein
the clock lines comprise a first clock line to which a first clock signal is input and a second clock line to which a second clock signal is input, and
the first clock signal and the second clock signal comprise signals having a same waveform with a shifted phase.

8. The display panel of claim 7, wherein
the plurality of first stages and the plurality of second stages each comprise a first clock terminal and a second clock terminal,
the first clock line and the second clock line are alternately connected to the first clock terminals of the plurality of first stages and the plurality of second stages, and
the second clock line and the first clock line are alternately connected to the second clock terminals of the plurality of first stages and the plurality of second stages.

9. The display panel of claim 1, further comprising:
clock lines connected to the scan driver, wherein the clock lines comprise a first clock line to which a first clock signal is input, a second clock line to which a second clock signal is input, a third clock line to which a third clock signal is input, and a fourth clock line to which a fourth clock signal is input,
the first clock signal and the second clock signal comprise signals having a same waveform with a shifted phase, and
the third clock signal and the fourth clock signal comprise signals having a same waveform with a shifted phase.

10. The display panel of claim 9, wherein
the plurality of first stages and the plurality of second stages each comprise a first clock terminal and a second clock terminal,
the first clock line and the second clock line are alternately connected to the first clock terminals of the plurality of first stages, the second clock line and the first clock line are alternately connected to the second clock terminals of the plurality of first stages,
the third clock line and the fourth clock line are alternately connected to the first clock terminals of the plurality of second stages, and
the fourth clock line and the third clock line are alternately connected to the second clock terminals of the plurality of second stages.

11. The display panel of claim 1, wherein
a first stage located at an i^{th} position among the plurality of first stages outputs a first scan signal to ones of the plurality of pixel circuits disposed in a (2i-1)^{th} row and in a 2i^{th} row,
a second stage located at an i^{th} position among the plurality of second stages outputs a second scan signal to the ones of the plurality of pixel circuits disposed in the (2i-1)^{th} row and the 2i^{th} row, and
i is a natural number greater than or equal to 1.

12. The display panel of claim 1, wherein
the scan driver further comprises a third driving circuit,
the third driving circuit comprises a plurality of third stages that output third scan signals to the plurality of pixel circuits, and
the plurality of third stages are spaced apart from the plurality of first stages and the plurality of second stages in a first direction.

13. The display panel of claim 12, wherein a width of one of the plurality of first stages in a second direction intersecting the first direction is equal to a width of one of the plurality of second stages in the second direction.

14. The display panel of claim 13, wherein a width of one of the plurality of third stages is equal to a sum of the width of the one of the plurality of first stages and the width of the one of the plurality of second stages.

15. A display panel comprising:
a plurality of pixel circuits disposed in a display area; and
a scan driver disposed in a peripheral area adjacent to the display area and comprising a first driving circuit, a second driving circuit, and a third driving circuit, wherein
the first driving circuit comprises a plurality of first stages that output first scan signals to the plurality of pixel circuits,
the second driving circuit comprises a plurality of second stages that output second scan signals to the plurality of pixel circuits,
the third driving circuit comprises a plurality of third stages that output third scan signals to the plurality of pixel circuits,
the plurality of first stages are disposed in a (3j-2)^{th} row,
the plurality of second stages are disposed in a (3j-1)^{th} row,
the plurality of third stages are disposed in a 3j^{th} row, and
j is a natural number greater than or equal to 1.

16. The display panel of claim 15, further comprising:
a first carry signal line that connects an input terminal of a first stage located at an n^{th} position among the plurality of first stages to an output terminal of a first stage located at an (n-1)^{th} position among the plurality of first stages;
a second carry signal line that connects an input terminal of a second stage located at an n^{th} position among the plurality of second stages to an output terminal of a second stage located at an (n-1)^{th} position among the plurality of second stages; and
a third carry signal line that connects an input terminal of a third stage located at an n^{th} position among the plurality of third stages to an output terminal of a third stage located at an (n-1)^{th} position among the plurality of third stages,
wherein n is a natural number greater than or equal to 2.

17. The display panel of claim 15, further comprising:
clock lines connected to the scan driver,
wherein the clock lines comprise a first clock line to which a first clock signal is input, a second clock line to which a second clock signal is input, a third clock line to which a third clock signal is input, and a fourth clock line to which a fourth clock signal is input,
the first clock signal and the second clock signal comprise signals having a same waveform with a shifted phase, and
the third clock signal and the fourth clock signal comprise signals having a same waveform with a shifted phase.

18. The display panel of claim 17, wherein
the plurality of first stages, the plurality of second stages, and the plurality of third stages each comprise a first clock terminal and a second clock terminal,
the first clock line and the second clock line are alternately connected to the first clock terminals of the plurality of first stages,
the second clock line and the first clock line are alternately connected to the second clock terminals of the plurality of first stages,
the first clock line and the second clock line are alternately connected to the first clock terminals of the plurality of second stages,
the second clock line and the first clock line are alternately connected to the second clock terminals of the plurality of second stages,
the third clock line and the fourth clock line are alternately connected to the first clock terminals of the plurality of third stages, and
the fourth clock line and the third clock line are alternately connected to the second clock terminals of the plurality of third stages.

19. The display panel of claim 15, wherein
a first stage located at an i^{th} position among the plurality of first stages output a first scan signal to ones of the plurality of pixel circuits disposed in a (2i-1)^{th} row and a 2i^{th} row,
a second stage located at an i^{th} position among the plurality of second stages output a second scan signal to the ones of the plurality of pixel circuits disposed in the (2i-1)^{th} row and the pixel circuits disposed in the 2i^{th} row,
a third stage located at an i^{th} position among the plurality of third stages output a third scan signal to the ones of the plurality of pixel circuits disposed in the (2i-1)^{th} row and the 2i^{th} row, and
i is a natural number greater than or equal to 1.

20. An electronic device comprising:
a display panel; and
a lower cover constituting an exterior of the electronic device and having an opening exposing a portion of the display panel in a front surface, wherein the display panel comprises:
a plurality of pixel circuits disposed in a display area; and
a scan driver disposed in a peripheral area adjacent to the display area and comprising a first driving circuit and a second driving circuit,
the first driving circuit comprises a plurality of first stages that output first scan signals to the plurality of pixel circuits,
the second driving circuit comprises a plurality of second stages that output second scan signals to the plurality of pixel circuits,
the plurality of first stages and the plurality of second stages are disposed alternately in different rows.
